(19) United States
(12) Patent Application Publication
(10) Pub. No.: US 2023/0098524 A1
(43) Pub. Date: Mar. 30, 2023

(54) APPARATUS, METHOD, AND SYSTEM FOR IMPLEMENTATION OF DYNAMIC WORKSTATIONS

(71) Applicant: Grey Orange Inc., Roswell, GA (US)

(72) Inventors: Manish Tiwari, Kanpur (IN); Pradeep Chauhan, Gurgaon (IN); Kushagra Kumar Rajput, Ghaziabad (IN); Sunil Kumar Sharma, Jaipur (IN)

(73) Assignee: Grey Orange Inc., Roswell, GA (US)

(21) Appl. No.: 17/453,612

(22) Filed: Nov. 4, 2021

(30) Foreign Application Priority Data
Sep. 30, 2021 (IN) 202121044496

(51) Int. Cl. G05B 19/418; G06Q 10/08

(52) U.S. Cl. CPC G05B 19/41895; G05B 19/4185; G06Q 10/087; G05B 2219/32037; G05B 2219/40154

(57) ABSTRACT

A movable operator station is disclosed. The movable operator station includes a first base plate, a second base plate, and a first support unit. A multi-tier structure is slidably coupled to the first base plate and is slidable in “X” axis between first and second positions. The second base plate is slidably coupled to the first base plate and is slidable between third and fourth positions. The first support unit is slidably coupled to the second base plate and is slidable along the “X” axis. A set of linking members links the first multi-tier structure to the first support unit. The set of linking members extends or collapses based on a movement of the second base plate along the “Y” axis. The first support unit and the set of linking members form a second multi-tier structure when the second base plate is at the fourth position.

### CROSS-RELATED APPLICATIONS

This application claims priority to Indian Application Serial No. 202121044496, filed Sep. 30, 2021, the contents of which are incorporated herein by reference.

### FIELD OF THE DISCLOSURE

The present disclosure relates generally to dynamic workstations, and more particularly, to a system for implementation of dynamic workstations in a storage facility.

### BACKGROUND

Modern storage facilities or warehouses handle a large number of items on a daily basis. These storage facilities or warehouses include pick-and-put stations or PPSs (e.g., operator stations or workstations) that act as an interface between the storage facilities and goods-to-person (GTP) systems. PPSs are workstations where pick and put operations or transformation operations are performed on inventory items for order fulfilment, inventory replenishment, or the like. Each PPS may be manned by one or more operators, for example, human operators, robotic operators, or a combination thereof. An operator manning a PPS may receive, by way of corresponding operator devices, commands or instructions (e.g., from a control server) for picking inventory items from the PPS and/or placing inventory items within the PPS.

Typically, the PPSs in the modern storage facilities are stationary and fixed at pre-determined locations in the storage facility, thereby rendering the layout in these storage facilities static. A storage facility with static PPSs (e.g., static layout) may be unable to respond to drastic changes in operating parameters (e.g., changes in type of order requests, changes in order frequency, changes in quantum of received orders, changes in number of available personnel at the storage facility or the like). Such scenarios may cause the storage facility to operate at sub-optimal efficiency (e.g., sub-par throughput of the storage facility) at various periods of time. Non-optimal efficiency at the storage facility may negatively affect business outcomes for any organization (e.g., an e-commerce organization) or entity associated with the storage facility.

In light of the foregoing, there exists a need for a technical solution that improves a design of PPSs at storage facilities and warehouses, to increase a throughput of the storage facilities and warehouses.

### SUMMARY

In an embodiment of the present disclosure, a movable operator station is disclosed. The movable operator station includes a first base plate oriented parallel to a floor surface in “XY” plane. The movable operator station further includes a set of support members attached to a bottom surface of the first base plate to maintain a gap between the first base plate and the floor surface. The movable operator station further includes a first multi-tier structure slidably coupled to the first base plate. The first multi-tier structure is slidable along “X” axis between a first position and a second position. The movable operator station further includes a second base plate slidably coupled to the first base plate. The second base plate is slidable along “Y” axis between a third position and a fourth position. The movable operator station further includes a first support unit slidably coupled to the second base plate. The first support unit is slidable along the “X” axis. The movable operator station further includes a first set of linking members that links the first multi-tier structure to the first support unit. The first set of linking members extends or collapses based on a movement of the second base plate along the “Y” axis. The first support unit is slidable along the “X” axis in conjunction with the first multi-tier structure, whereby the first support unit and the first set of linking members form a second multi-tier structure when the second base plate is at the fourth position.

In another embodiment of the present disclosure, a system for implementation of dynamic workstations is disclosed. The system includes a set of movable operator stations. Each of the set of movable operator stations includes a first base plate oriented parallel to a floor surface in “XY” plane. Each of the set of movable operator stations further includes a set of support members attached to a bottom surface of the first base plate to maintain a gap between the first base plate and the floor surface. Each of the set of movable operator stations further includes a first multi-tier structure slidably coupled to the first base plate. The first multi-tier structure is slidable along “X” axis between a first position and a second position. Each of the set of movable operator stations further includes a second base plate slidably coupled to the first base plate. The second base plate is slidable along “Y” axis between a third position and a fourth position. Each of the set of movable operator stations further includes a first support unit slidably coupled to the second base plate. The first support unit is slidable along the “X” axis. Each of the set of movable operator stations further includes a first set of linking members that links the first multi-tier structure to the first support unit. The first set of linking members extends or collapses based on a movement of the second base plate along the “Y” axis. The first support unit is slidable along the “X” axis in conjunction with the first multi-tier structure, whereby the first support unit and the first set of linking members form a second multi-tier structure when the second base plate is at the fourth position. The system further includes a server configured to determine, from a plurality of locations in a storage facility, a first location for installation of a first movable operator station, of the set of movable operator stations, within the storage facility. The system further includes an automated guided vehicle (AGV) configured to receive, from the server, a set of instructions to transport the first movable operator station to the determined first location. The AGV is further configured to transport, based on the received set of instructions, the first movable operator station from a current location of the movable operator station to the determined first location.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates an exemplary environment for implementation of dynamic workstations, in accordance with an exemplary embodiment of the present disclosure;

FIG. 2 is a diagram that illustrates a perspective view of a first movable operator station of FIG. 1, in accordance with an exemplary embodiment of the present disclosure;

FIG. 3 is a diagram that illustrates a side view of the first movable operator station shown in FIG. 2, in accordance with an exemplary embodiment of the disclosure;

FIG. 4 is a diagram that illustrates a front view of the first movable operator station shown in FIG. 2, in accordance with an exemplary embodiment of the disclosure;

FIG. 5 is a diagram that illustrates a bottom view of the first movable operator station shown in FIG. 2, in accordance with an exemplary embodiment of the disclosure;

FIG. 6 is a diagram that illustrates a perspective view of the first movable operator station, in accordance with another exemplary embodiment of the disclosure;

FIG. 7 is a diagram that illustrates a perspective view of the first movable operator station when a base plate of the first movable operator station is extended along “Y” axis, in accordance with an exemplary embodiment of the disclosure;

FIG. 8 is a diagram that illustrates a side view of the first movable operator station when the base plate of the first movable operator station is extended along the “Y” axis, in accordance with an exemplary embodiment of the disclosure;

FIG. 9 is a diagram that illustrates a top view of the first movable operator station, in accordance with an exemplary embodiment of the disclosure;

FIG. 10 is a diagram that illustrates a bottom view of the first movable operator station when the base plate of the first movable operator station is extended along the “Y” axis, in accordance with an exemplary embodiment of the disclosure;

FIG. 11 is a diagram that illustrates a perspective view of the first movable operator station when the second base plate 212 is extended along the “Y” axis, in accordance with another exemplary embodiment of the disclosure;

FIG. 12 is a block diagram that illustrates a perspective view of the first movable operator station when a multi-tier structure of the first movable operator station is extended along “X” axis and the base plate is extended along the “Y” axis, in accordance with an exemplary embodiment of the disclosure;

FIG. 13 is a diagram that illustrates a front view of the first movable operator station when the multi-tier structure of the first movable operator station is extended along the “X” axis and the base plate is extended along the “Y” axis, in accordance with an exemplary embodiment of the disclosure;

FIG. 14 is a diagram that illustrates a perspective view of the first movable operator station when the multi-tier structure of the first movable operator station is extended along the “X” axis and the base plate is extended along the “Y” axis, in accordance with another exemplary embodiment of the disclosure;

FIG. 15 is a diagram that illustrates a perspective view of the first movable operator station when the multi-tier structure is extended along the “X” axis and the base plate is retracted along the “Y” axis, in accordance with an exemplary embodiment of the disclosure;

FIG. 16 is a diagram that illustrates a control server of FIG. 1, in accordance with an exemplary embodiment of the present disclosure; and

FIGS. 17A and 17B, collectively represent a flow chart that illustrates a process for implementing dynamic workstations, in accordance with an exemplary embodiment of the disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Various embodiments of the disclosure provide a movable operator station (e.g., dynamic pick-and-put station or dynamic workstation) and a system for implementation of dynamic workstations. The system may include the movable operator stations, a server, and a set of autonomous guided vehicles (AGVs). The movable operator station includes a first base plate oriented parallel to a floor surface of a storage facility. The floor surface of the storage facility is in “XY” plane. The movable operator station further includes a set of support members (e.g., support legs) attached to a bottom surface of the first base plate to maintain a gap between the first base plate and the floor surface. The movable operator station further includes a first multi-tier structure slidably coupled to the first base plate. The first multi-tier structure is coupled to the first base plate by way of a first set of sliding members (e.g., guide rails) that is mounted on a top surface of the first base plate.

The first multi-tier structure is slidable along “X” axis between a first position and a second position The movable operator station further includes a second base plate slidably coupled to the first base plate. The second base plate is slidable along “Y” axis between a third position and a fourth position. A second set of sliding members is attached to the bottom surface of the first base plate. The second base plate is slidably coupled to the first base plate by way of the second set of sliding members. Attached to a bottom surface of the second base plate is a set of wheels that is in contact with the floor surface of the storage facility. The set of wheels facilitates movement of the second base plate along the “Y” axis. The second base plate includes an identification marker (e.g., a barcode, a quick response code, or the like) on the bottom surface of the second base plate. The movable operator station further includes a first support unit slidably coupled to the second base plate. The first support unit is coupled to the second base plate by way of a third set of sliding members (e.g., guide rails) mounted on a top surface of the second base plate. The first support unit is slidable along the “X” axis.

The movable operator station further includes a first set of linking members (e.g., telescopic foldable tubes) that links the first multi-tier structure to the first support unit. The first set of linking members extends or collapses based on a movement of the second base plate along the “Y” axis. The first support unit is slidable along the “X” axis in conjunction (e.g., in tandem) with the first multi-tier structure. When the second base plate is at the fourth position, the first set of linking members is fully extended. The fully extended first set of linking members and the first support unit, collectively, form a second multi-tier structure.

The server determines, for each of a plurality of locations included in the storage facility, a current level of availability of a corresponding location. For example, the server determines whether each of the plurality of location is currently empty or occupied. Further, the server determines, for each of the plurality of locations, a level of throughput of the movable operator station at a corresponding location. In other words, the server determines or estimates, for each of the plurality of locations, an expected level of throughput of the movable operator station at the corresponding location. Based on the expected level of throughput at each of the plurality of locations and the current level of availability of each of the plurality of locations, the server determines, from the plurality of locations, a first location for installation of the movable operator station. Based on the determination of the first location, the server may communicate, to a first AGV of the set of AGVs, a set of instructions to transport the movable operator station from a current location of the movable operator station to the first location. The set of instructions may be indicative of the identification marker of the movable operator station. The first AGV may, based on the reception of the set of instructions, transport the movable operator station from a current location of the movable operator station to the first location.

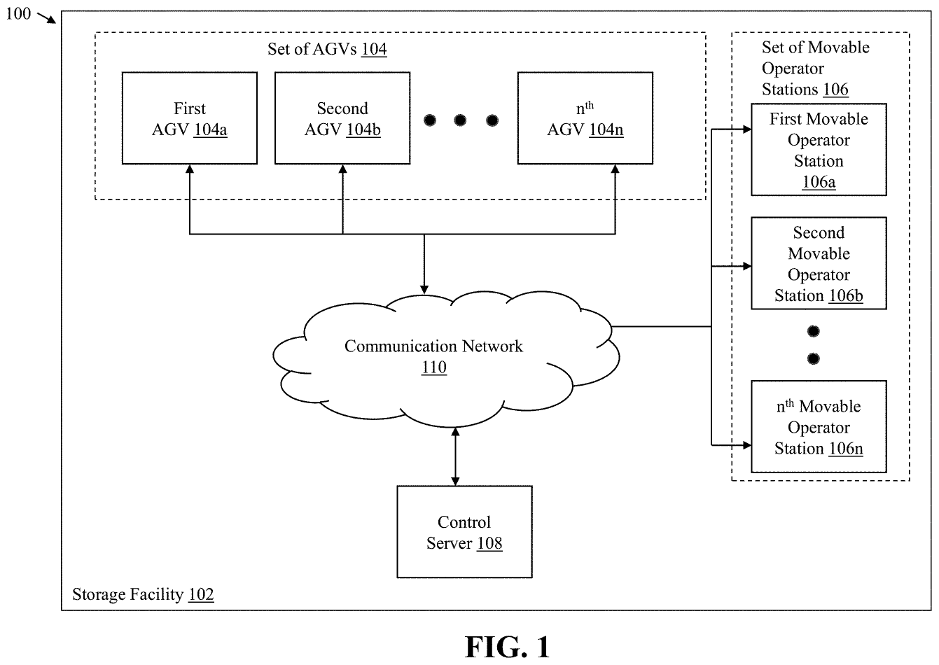

FIG. 1 is a block diagram that illustrates an exemplary environment 100 for implementation of dynamic workstations, in accordance with an exemplary embodiment of the present disclosure. The environment 100 shows a storage facility 102. The storage facility 102 includes first through n^{th} automated guided vehicles (AGVs) 104a-104n, first through n^{th} movable operator stations 106a-106n, and a control server 108. The first through n^{th} AGVs 104a-104n are collectively referred to as “set of AGVs 104”. Similarly, the first through n^{th} movable operator stations 106a-106n are collectively referred to as “set of movable operator stations 106”. The control server 108 communicates with the set of AGVs 104 and the set of movable operator stations 106 by way of a communication network 110 or through separate communication networks established therebetween.

The storage facility 102 may store various inventory items for fulfillment and/or selling. Examples of the storage facility 102 may include, but are not limited to, a forward warehouse, a backward warehouse, a manufacturing facility, an item sorting facility, a retail store, or the like). The inventory items may include, but are not limited to, objects such as packages, apparel, sheets, cartons, or the like. The inventory items are stored in a storage area of the storage facility 102. The storage area may be of any shape, for example, a rectangular shape.

In one embodiment, the storage facility 102 may include a storage area that includes a plurality of storage units (not shown). Examples of the plurality of storage units (e.g., mobile storage units or MSUs) may include, but are not limited to, multi-tier racks, pallet racks, portable mezzanine floors, vertical lift modules, horizontal carousels, or vertical carousels. In an embodiment, each of the plurality of storage units may correspond to MSUs that are movable from one location to another location in the storage facility 102. In such a scenario, the movement of the plurality of storage units may be enabled, for example, by the set of AGVs 104.

The first AGV 104a may include suitable logic, instructions, circuitry, interfaces, and/or code, executable by the circuitry, for executing various operations, for example, transportation of payloads (e.g., the set of movable operator stations 106 and the plurality of storage units) between various locations within the storage facility 102. The first AGV 104a may be configured to execute the various operations based on instructions and/or commands received from the control server 108. The first AGV 104a may include various sensors (e.g., image sensors, RFID sensors, or the like) for determining a relative position thereof within the storage facility 102 and/or identifying a payload (e.g., a storage unit or a movable operator station) for transportation. It will be apparent to those of skill in the art that the second through n^{th} AGVs 104b-104n may be functionally similar to the first AGV 104a.

The first movable operator station 106a may be a pick-and-put station (PPS) that is movable between various locations in the storage facility 102. In other words, the first movable operator station 106a is a dynamic PPS or a dynamic workstation that acts as an interface between the storage facility 102 and a goods-to-person system. For the sake of brevity, the term “movable operator station” and “dynamic PPS” are used interchangeably throughout the disclosure. The first movable operator station 106a facilitates pick and put operations by an operator (e.g., a human operator, a robotic operator, or a combination thereof) at the storage facility 102. Pick and/or put operations may be performed by the operator for various purposes such as, but not limited to, order fulfilment, inventory replenishment, item retrieval from the plurality of storage units, or the like. The operator may perform the pick and/or put operations, based on instructions or commands from the control server 108. Based on the received commands or instructions, the operator at the first movable operator station 106a may place inventory items in the plurality of storage units or retrieve inventory items from the plurality of storage units. An item retrieval operation may involve retrieving one or more inventory items from a storage unit (e.g., the plurality of storage units) and placing the retrieved inventory items in one or more order bins (e.g., boxes, cartons, totes, or the like) at the first movable operator station 106a.

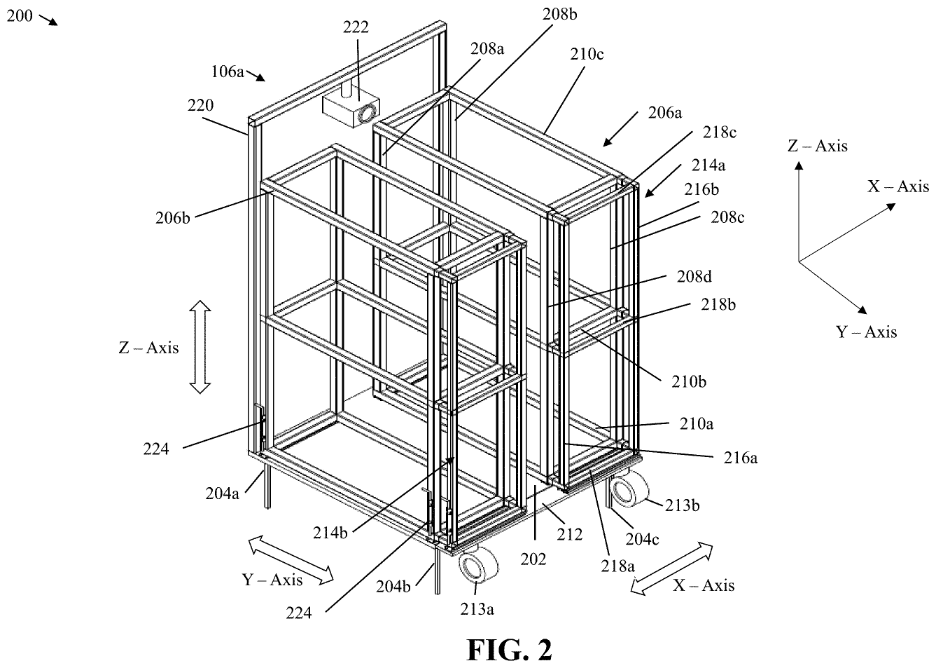

In a non-limiting example, the instructions or commands from the control server 108 may be displayed on a display screen (not shown) included in the first movable operator station 106a. One or more electronic devices (e.g., components, sensors, or the like) that are communicably coupled to the control server 108 may be included in the first movable operator station 106a. Structure and functionality of the first movable operator station 106a is explained in conjunction with FIGS. 2-16. It will be apparent to those of skill in the art that other movable operator stations (e.g., the second through n^{th} movable operator stations 106b-106n) may be structurally and functionally similar to the first movable operator station 106a.

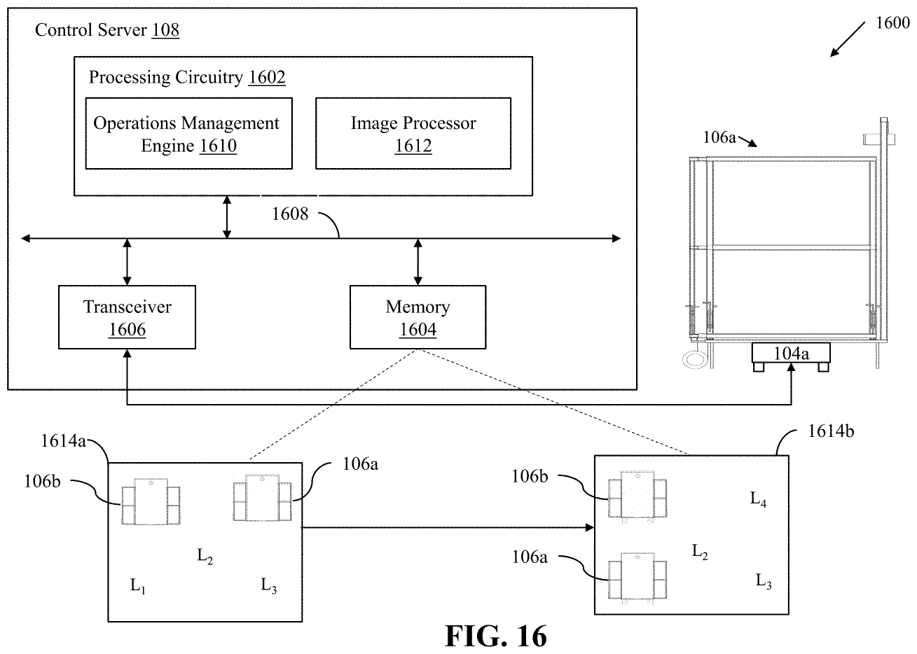

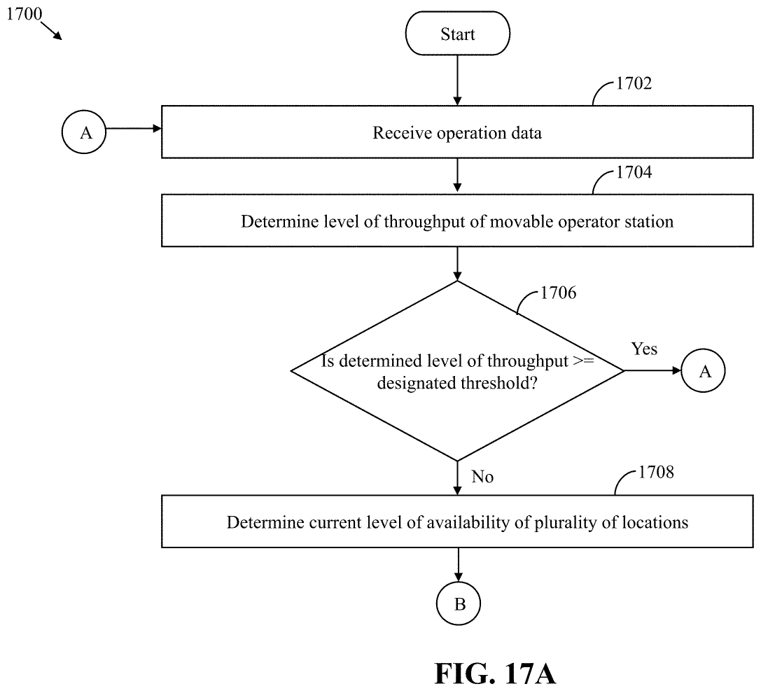

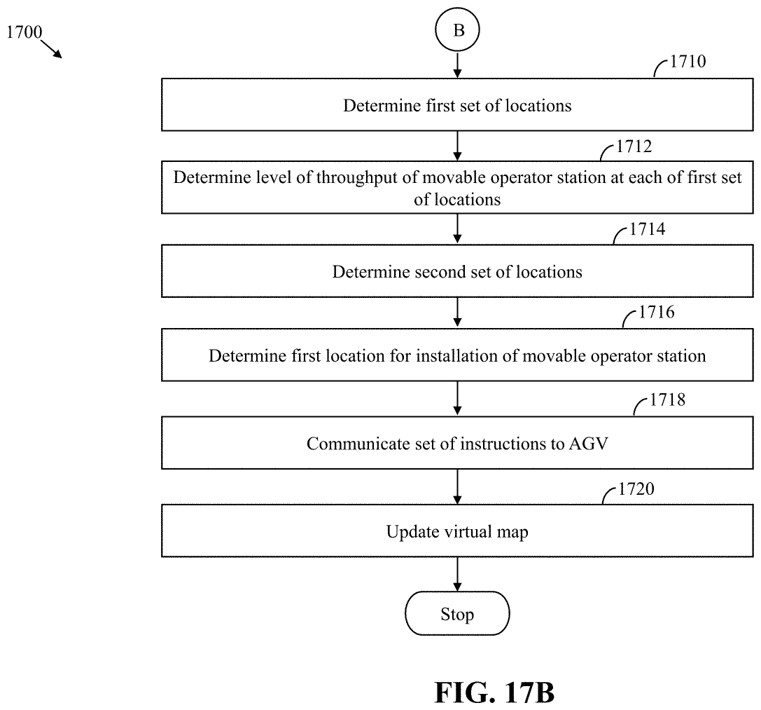

The control server 108 may include suitable logic, instructions, circuitry, interfaces, and/or code, executable by the circuitry, for facilitating various operations in the storage facility 102. The control server 108 may be maintained by a warehouse management authority or a third-party entity that facilitates inventory management operations for the storage facility 102. Various components of the control server 108 and their functionalities are described later in conjunction with FIGS. 16 and 17A-17B. The control server 108 may be further configured to receive, for example, from an external server (not shown) various types of requests such as, but not limited to, requests for order fulfilment, requests for inventory replenishment, requests for order sorting, requests for palletization of inventory items, requests for de-palletization of inventory items, or the like.

Based on received requests, the control server 108 may be configured to issue commands and/or instructions to the set of AGVs 104; electric, electronic, and/or electromechanical devices or systems associated with the set of movable operator stations 106; or the like. For example, the control server 108 may communicate or issue instructions (e.g., commands) to the set of AGVs 104 for transporting storage units between various locations in the storage facility 102. The control server 108 may store, in its memory, a virtual map (e.g., layout) of the storage facility 102. Further, based on the virtual map and information received from the set of AGVs 104, the control server 108 may track a real-time location of each of the set of AGVs 104 in the storage facility 102.

The control server 108 may be further configured to receive data indicative of a level of throughput of each of the set of movable operator stations 106. The received data may be indicative of a number of operations (e.g., pick and/or put operations), per unit time (e.g., throughput), being performed by an operator at each movable operator station of the set of movable operator stations 106. Further, the received data may be indicative of a current location of each of the set of movable operator stations 106.

In one embodiment, the control server 108 may determine, based on the received data, that a current level of throughput of one of the set of movable operator stations 106 (e.g., the first movable operator station 106a) is below a designated or optimal threshold. For example, the control server 108 may determine that a current level of throughput of the first movable operator station 106a is below the designated threshold. The control server 108 may further determine whether a current location of the first movable operator station 106a is negatively affecting the current level of throughput of the first movable operator station 106a. For example, if the current location of the first movable operator station 106a is relatively far away from the storage area (not shown), the current level of throughput of the first movable operator station 106a may be negatively affected by the current location of the first movable operator station 106a.

Based on the stored virtual map and the determination that the current location of the first movable operator station 106a is negatively affecting the current level of throughput of the first movable operator station 106a, the control server 108 may determine a current level of availability (e.g., occupied, empty, soon to be vacated, soon to be occupied, or the like) of a plurality of locations included in the storage facility 102. Based on the determined current level of availability of the plurality of locations, the control server 108 may determine a first set of locations that is currently available (and/or soon to be available) for installation of the first movable operator station 106a. In one embodiment, the first set of locations may be the same as the plurality of locations. In another embodiment, the first set of locations may be a subset of the plurality of locations. Further, the control server 108 may determine or estimate, for each of the first set of locations, a level of throughput (e.g., expected level of throughput) of the first movable operator station 106a at a corresponding location. In one embodiment, based on the determination of a level of throughput (e.g., the expected level of throughput) of the first movable operator station 106a at each of the first set of locations, the control server 108 may determine a second set of locations for installation of the first movable operator station 106a.

The second set of locations may include one or more locations for which the determined level of throughput of the first movable operator station 106a at a corresponding location is greater than or equal to the designated threshold. In one embodiment, the second set of locations may be the same as the first set of locations. In another embodiment, the first set of locations may be a subset of the first set of locations. The control server 108 may determine, from the second set of locations, a location (e.g., a first location) within the storage facility 102 for installation of the first movable operator station 106a. In a non-limiting example, it is assumed that the determined level of throughput (e.g., the expected level of throughput) of the first movable operator station 106a at the first location is greater than the determined level of throughput of the first movable operator station 106a at any other location of the second set of locations. In other words, the determination of the first location, for the installation of the first movable operator station 106a, is based on the current availability of the first location and the determined level of throughput of the first movable operator station 106a for the first location.

Consequently, the control server 108 may communicate to an AGV (e.g., the first AGV 104a), of the set of AGVs 104, a set of instructions (e.g., commands) to transport the first movable operator station 106a from the current location of the first movable operator station 106a to the determined first location. The set of instructions may include or may be indicative of a first route to be followed by the first AGV 104a to reach the current location of the first movable operator station 106a from the current location of the first AGV 104a. The set of instructions may further include or may be further indicative of a second route to be followed by the first AGV 104a from the current location of the first movable operator station 106a to the first location for installation of the first movable operator station 106a. The set of instructions may further include or may be further indicative of a set of identification details of the first movable operator station 106a. The set of identification details may be indicative of an identification marker (e.g., a barcode, a quick response or QR code, or the like) that is attached or affixed to the first movable operator station 106a and that uniquely identifies the first movable operator station 106a among the set of movable operator stations 106. In other words, the set of instructions is indicative of the identification marker of the first movable operator station 106a.

In one embodiment, one or more movable operator stations (e.g., the first movable operator station 106a) may not be in use. For example, the operator at the first movable operator station 106a may have completed all assigned tasks or operations (e.g., pick and/or put operations). In another example, the first movable operator station 106a may not be in use (e.g., due to malfunctioning, low count of received order requests, or the like). In such scenarios, the control server 108 may determine that the first movable operator station 106a is to be temporarily stowed away (e.g., in a secondary storage area or a closet in the storage facility 102) since the first movable operator station 106a is not in use. In a non-limiting example, the secondary storage area may be a location in the storage facility 102 that may be used to store operator stations that are not in use. Based on the determination that the first movable operator station 106a is to be temporarily stowed away, the control server 108 may communicate a set of instructions (e.g., commands) to the first AGV 104a, indicating that the first movable operator station 106a is to be transported to the secondary storage area. Based on the set of instructions, the first AGV 104a may transport the first movable operator station 106a to the secondary storage area. A location, space, or area vacated (e.g., previously occupied) by the first movable operator station 106a may now be available for utilization for other activities.

In another embodiment, the control server 108 may determine that a set of additional operator stations is required to facilitate operations in the storage facility 102. For example, based on the received data and/or the current level of throughput of each of the set of movable operator stations 106, the control server 108 may determine that the set of additional operator stations is required to handle increased load (e.g., increased number of order requests) in the storage facility 102. In another example, the control server 108 may determine that a set of value-added services for inventory items (e.g., ironing of apparel, repairing of gadgets, or the like), in addition to pick operations or put operations, is required for order fulfilment. In such a scenario, the control server 108 may determine that the set of additional operator stations is required to facilitate the set of value-added services for the inventory items. In another example, the control server 108 may determine that a set of previously stowed away movable operator stations (e.g., the first movable operator station 106a in the secondary storage area) is now required (e.g., temporarily or permanently required) for facilitating operations in the storage facility 102. In another example, based on a lack of storage units or a lack of storage space in the plurality of storage units, the control server 108 may determine that the set of additional operator stations is required for creating additional storage space (e.g., temporary or permanent storage space). Therefore, based on various requirements, the control server 108 may determine that the set of additional operator stations (e.g., the first movable operator station 106a) is to be installed for facilitating operations in the storage facility. Process of installation of the set of additional operator stations may be similar to a process of installation of the first movable operator station 106a as described earlier.

The control server 108 may be a network of computers, a software framework, or a combination thereof, that may provide a generalized approach to create the server implementation. Examples of the control server 108 may include, but are not limited to, personal computers, laptops, mini-computers, mainframe computers, any non-transient and tangible machine that can execute a machine-readable code, cloud-based servers, distributed server networks, or a network of computer systems. The control server 108 may be realized through various web-based technologies such as, but not limited to, a Java web-framework, a .NET framework, a personal home page (PHP) framework, or any other web-application framework.

In some embodiments, the control server 108 may be a physical or cloud data processing system on which a server program runs. The control server 108 may be implemented in hardware or software, or a combination thereof. In one embodiment, the control server 108 may be implemented in computer programs executing on programmable computers, such as personal computers, laptops, or a network of computer systems.

The communication network 110 is a medium (e.g., network ports, communication channels, or combination thereof) through which content and messages are transmitted between the set of AGVs 104, electronic devices or components included in the set of movable operator stations 106, and the control server 108. Examples of the communication network 110 may include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 110 in accordance with various wired and wireless communication protocols, such as Transmission Control Protocol and Internet Protocol (TCP/IP), User Datagram Protocol (UDP), Long Term Evolution (LTE) communication protocols, Hypertext Transfer Protocol (HTTP), File Transfer Protocol (FTP), Simple Mail Transfer Protocol (SMTP), Domain Network System (DNS), Common Management Interface Protocol (CMIP), or any combination thereof.

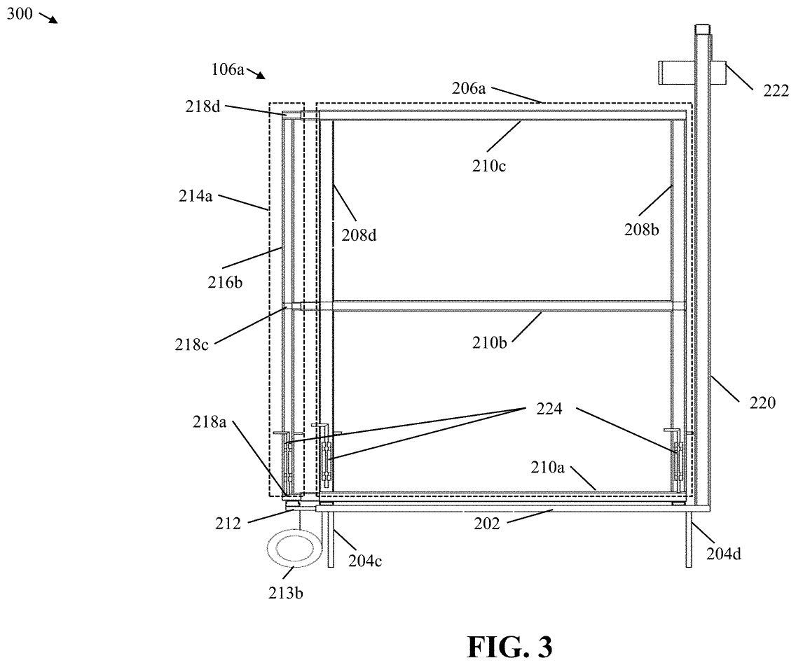

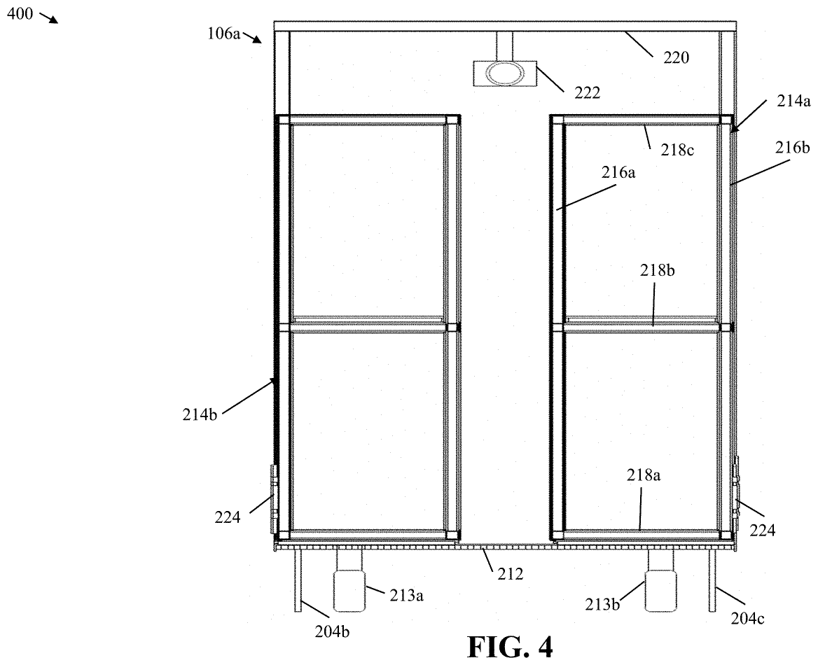

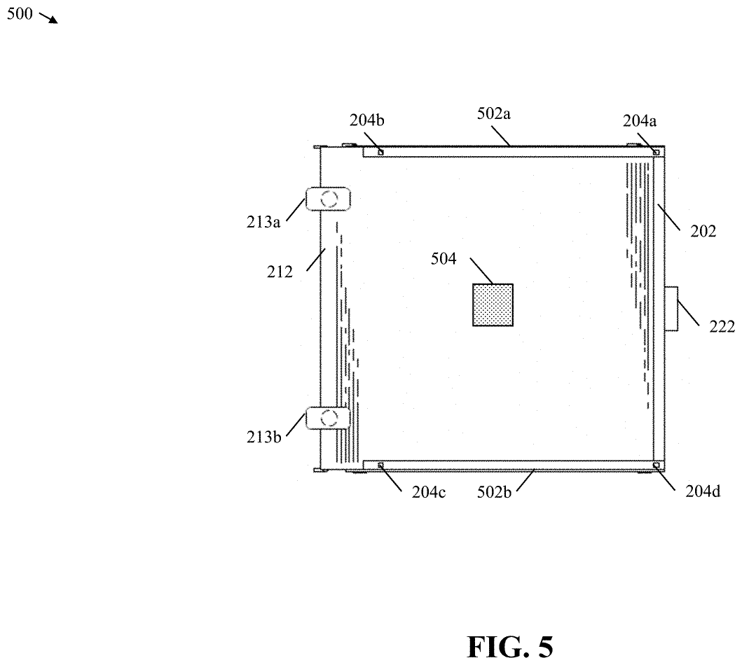

FIG. 2 is a diagram 200 that illustrates a perspective view of the first movable operator station 106a, in accordance with an exemplary embodiment of the present disclosure. FIGS. 3, 4, and 5 are explained in conjunction with FIG. 2. FIG. 3 is a diagram 300 that illustrates a side view of the first movable operator station 106a shown in FIG. 2, in accordance with an exemplary embodiment of the present disclosure. FIG. 4 is a diagram 400 that illustrates a front view of the first movable operator station 106a shown in FIG. 2, in accordance with an exemplary embodiment of the present disclosure. FIG. 5 is a diagram 500 that illustrates a bottom view of the first movable operator station 106a shown in FIG. 2, in accordance with an exemplary embodiment of the present disclosure.

Referring now to FIG. 2, The first movable operator station 106a includes a first base plate 202. The first base plate 202 is oriented parallel to a floor surface of the storage facility 102 that is in “XY” plane. In other words, the first base plate 202 is in the “XY” plane. Attached to a bottom surface of the first base plate 202 are first through fourth support members (e.g., support legs) 204a-204d (shown in FIGS. 2 and 3). A gap is maintained between the first base plate 202 and a floor surface of the storage facility 102 by way of the first through fourth support members 204a-204d. Additionally, the first through fourth support members 204a-204d provide support to the first base plate 202. For the sake of brevity, the first through fourth support members 204a-204d are interchangeably referred to as “the set of support members 204” throughout the disclosure.

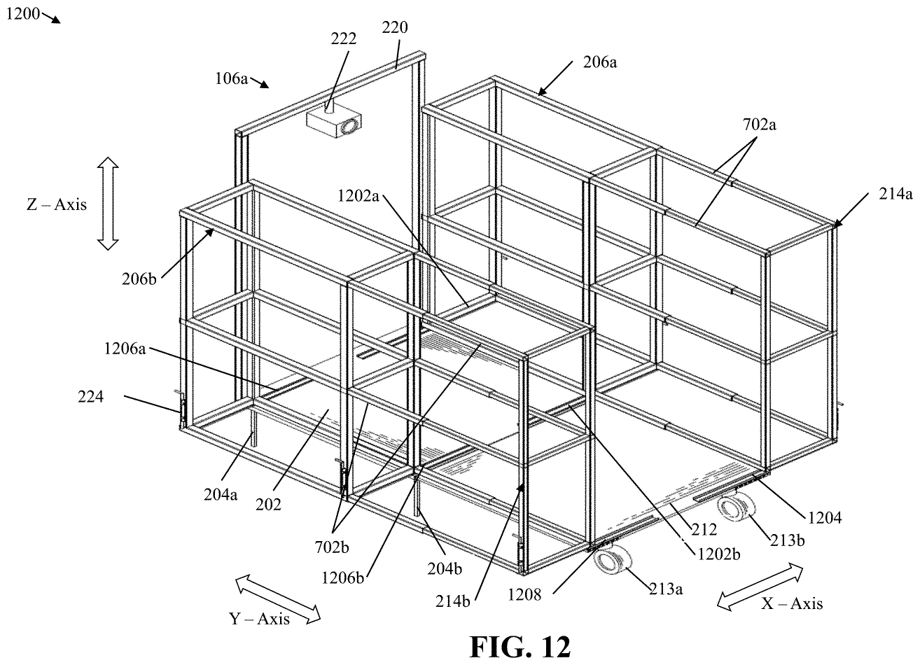

The first movable operator station 106a further includes a first multi-tier structure 206a. The first multi-tier structure 206a is slidably coupled to the first base plate 202. In other words, the first multi-tier structure 206a is mounted on a top surface of the first base plate 202 by way of a first set of sliding members (e.g., guide rails, shown in FIG. 12). A sliding member (e.g., the first set of sliding members) may be defined as a sliding guide (e.g., guide rails, or the like) that enables a structure (e.g., the first multi-tier structure 206a) to be slid across a length of the sliding guide. In one embodiment, the first set of sliding members enable, thereon, movement (e.g., sliding movement) of the first multi-tier structure 206a in “X” axis. The first multi-tier structure 206a may be slid between a first position and a second position with respect to the first base plate 202. The first position and the second position may refer to opposing endpoints or edges of the first set of sliding members and define a range of movement of the first multi-tier structure 206a on the first set of sliding members. In a current embodiment, the first multi-tier structure 206a is slid to the second position by sliding the first multi-tier structure 206a in the “X” axis to a maximum distance away from the first base plate 202 (as allowed by the first set of sliding members). Similarly, the first multi-tier structure 206a is slid to the first position by sliding the first multi-tier structure 206a a maximum distance in the “X” axis towards the first base plate 202 (as allowed by the first set of sliding members).

Movement of the first multi-tier structure 206a is shown in conjunction with FIGS. 2, 7, 12, and 15. The first multi-tier structure 206a includes a first plurality of posts and a first plurality of separators. In a non-limiting example, the first plurality of posts is shown to include first through fourth posts 208a-208d. However, in an actual implementation, the second plurality of posts may include any number of posts without deviating from the scope of the disclosure. Hereinafter, the first plurality of posts are designated and referred to as “the first plurality of posts 208”.

In a non-limiting example, the first plurality of separators is shown to include first through third separators 210a-210c. However, in an actual implementation, the first plurality of separators may include any number of separators without deviating from the scope of the disclosure. Hereinafter, the first plurality of separators are designated and referred to as “the first plurality of separators 210”. In one embodiment, one of the first plurality of separators 210 (e.g., the first separator 210a) is designed to slot into one of the first set of sliding members, such that the first multi-tier structure 206a is slidable on the first set of sliding members, thereby providing room (e.g., space) for the operator (e.g., a human operator, a robotic operator, or the like) to perform pick and/or put operations.

The first plurality of posts 208, in conjunction with the first plurality of separators 210, form a first plurality of storage shelves. In a non-limiting example, the first plurality of storage shelves includes three storage shelves (e.g., storage shelves at a base level, a middle level, and a top level) since the first plurality of separators 210 includes three separators (e.g., the first through third separators 210a-210c at the base level, the middle level, and the top level, respectively). In a current embodiment, for the sake of brevity, the first plurality of separators 210 are shown to be hollow. However, in an actual implementation, each of the first plurality of separators 210 may include or have installed there one or more storage mechanisms, such as, but not limited to, solid structures (e.g., planks), collapsible bags, hooks with attached bags (e.g., tote bags), or the like. Each of the first plurality of separators 210 may include or have installed, thereon, one of the one or more storage mechanisms to facility storage (e.g., temporary storage) of items (e.g., for order fulfillment, inventory replenishment, or the like) on each of the first plurality of storage shelves.

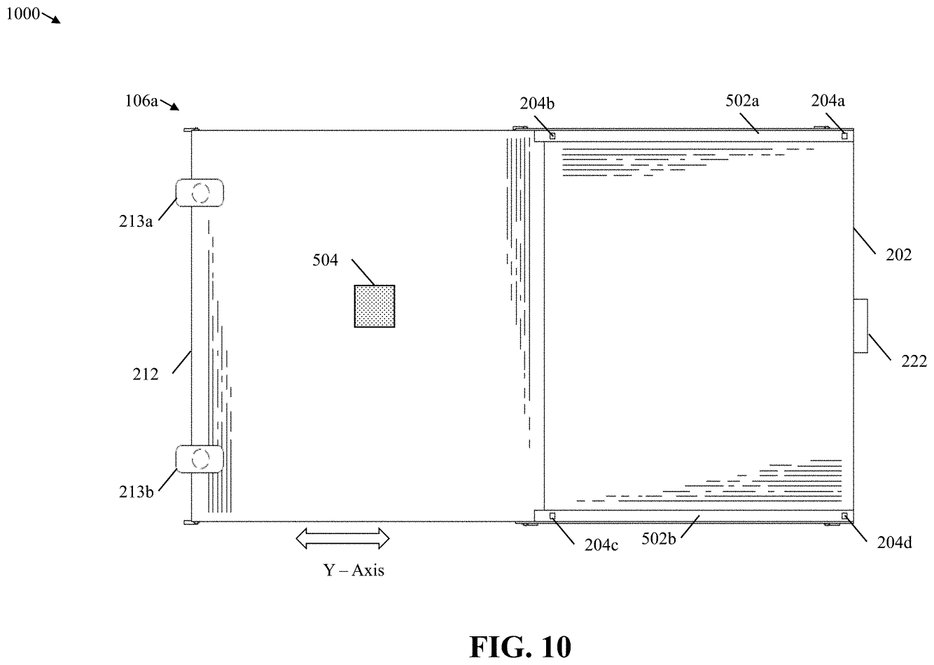

The first movable operator station 106a further includes a second base plate 212 that is slidably coupled to the first base plate 202. The second base plate 212 is slidably coupled to the first base plate 202 by way of a second set of sliding members (e.g., guide rails; shown in FIGS. 5 and 10) that is attached to the bottom surface of the first base plate 202. In one embodiment, a set of wheels 213 (e.g., first and second wheels 213a and 213b) is attached to a bottom surface of the second base plate 212. The set of wheels 213 (e.g., castor wheels, or the like) is in contact with the floor surface of the storage facility 102 and rotates (e.g., rolls), with respect to the floor surface to facilitate movement of the second base plate 212 along the “Y” axis. The set of wheels 213 is further designed to provide support to the second base plate 212. In a non-limiting example, the set of wheels 213 is shown to include only two wheels (e.g., the first and second wheels 213a and 213b). However, in an actual implementation, the set of wheels 213 may include any number of wheels, without deviating from the scope of the disclosure. In another embodiment, any other type of support member (e.g., support legs) may be used instead of the set of wheels 213. The set of wheels 213 may be movable along both the “X” axis and the “Y” axis (e.g., movable in any direction in the “XY” plane) to facilitate movement of the first movable operator station 106a (e.g., when loaded with inventory items or when inventory items are absent) within the storage facility 102a. In such a scenario, an AGV (e.g., the first AGV 104a) may not be required for transportation of the first movable operator station 106a within the storage facility 102. Movement of the first movable operator station 106a may be manual or automated. If movement of the first movable operator station 106a is automated, the first movable operator station 106a may include one or more electrical, electronic, and/or electromechanical systems (e.g., microcontrollers, sensors, limit switches, motors, actuators, or the like) communicably coupled to the control server 108. The one or more electrical, electronic, and/or electromechanical systems may facilitate automated movement of the first movable operator station 106a, based on instructions received from the control server 108.

In one embodiment, the set of wheels 213 may be coupled to a stopping mechanism (e.g., stoppers, wheel locks, or the like; not shown). The stopping mechanism may be engaged when the first movable operator station 106a is in use (e.g., when pick and put operations are being performed by the operator at the first movable operator station 106a). The stopping mechanism, when engaged, may prevent unintended movement of the set of wheels 213 (i.e., unintended movement of the first movable operator station 106a) when the first movable operator station 106a is in use.

The second base plate 212 may be slidable, along the “Y” axis, between a third position and a fourth position with respect to the first base plate 202. The third position and the fourth position may refer to opposing endpoints or edges of the second set of sliding members and define a range of movement of the second base plate 212 on the second set of sliding members. In a current embodiment, the second base plate 212 is slid to the fourth position by sliding the second base plate 212 in the “Y” axis to a maximum distance away from the first base plate 202 (as allowed by the second set of sliding members). Similarly, the second base plate 212 is slid to the third position by sliding the second base plate 212 a maximum distance in the “Y” axis towards the first base plate 202 (as allowed by the second set of sliding members).

The first movable operator station 106a further includes a first support unit 214a that is slidably coupled to the second base plate 212. The second base plate 212 acts as a support platform for the first support unit 214a. In one embodiment, the first support unit 214a is mounted on a top surface of the second base plate 212 by way of a third set of sliding members (e.g., guide rails, shown in FIG. 12). The third set of sliding members is attached to the top surface of the second base plate 212 such that the first support unit 214a is slidable along the “X” axis with respect to the second base plate 212.

The first support unit 214a may be slidable, along the “X” axis, between a fifth position and a sixth position with respect to the second base plate 212. The fifth position and the sixth position may refer to opposing endpoints or edges of the third set of sliding members and define a range of movement of the first support unit 214a on the third set of sliding members. In the current embodiment, the first support unit 214a is slid to the sixth position by sliding the first support unit 214a along the “X” axis to a maximum distance away from the second base plate 212 (as allowed by the third set of sliding members). Similarly, the first support unit 214a is slid to the fifth position by sliding the first support unit 214a to a maximum distance along the “X” axis towards the second base plate 212 (as allowed by the third set of sliding members).

The first support unit 214a includes a second plurality of posts and a second plurality of separators. In a non-limiting example, the second plurality of posts is shown to include fifth and sixth posts 216a and 216b. However, in an actual implementation, the first plurality of posts may include any number of posts without deviating from the scope of the disclosure. Hereinafter, the second plurality of posts are designated and referred to as “the second plurality of posts 216”.

A count of separators included in the first plurality of separators 210 and a count of separators included in the second plurality of separators may be same. In a non-limiting example, the second plurality of separators is shown to include fourth through sixth separators 218a-218c (horizontally aligned with the first through third separators 210a-210c at the base level, the middle level, and the top level, respectively). However, in an actual implementation, the first plurality of separators may include any number of separators without deviating from the scope of the disclosure. Hereinafter, the second plurality of separators are designated and referred to as “the second plurality of separators 218”.

In one embodiment, one of the second plurality of separators 218 is designed to slot into one of the third set of sliding members, such that second multi-tier structure is slidable on the third set of sliding members, thereby providing room (e.g., space) for the operator (e.g., a human operator, a robotic operator, or the like) to perform pick and/or put operations.

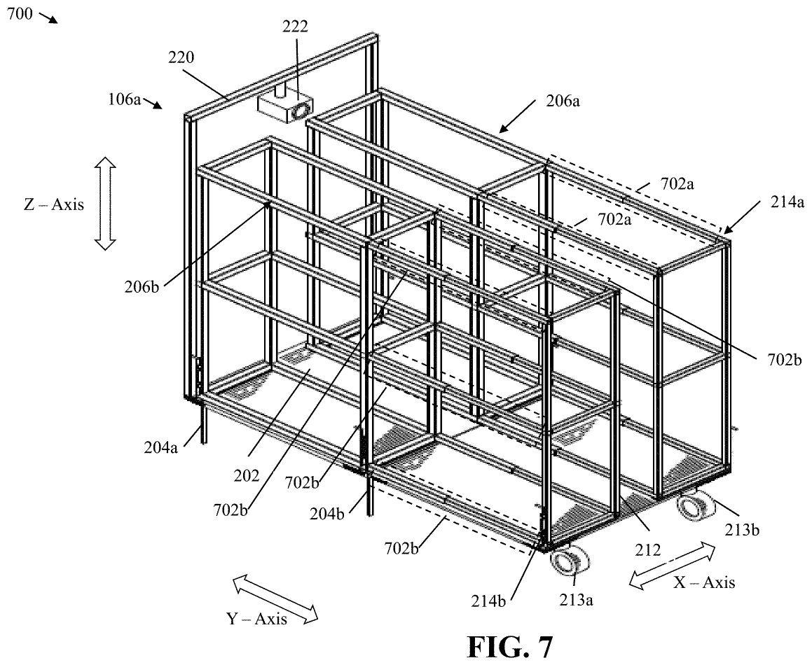

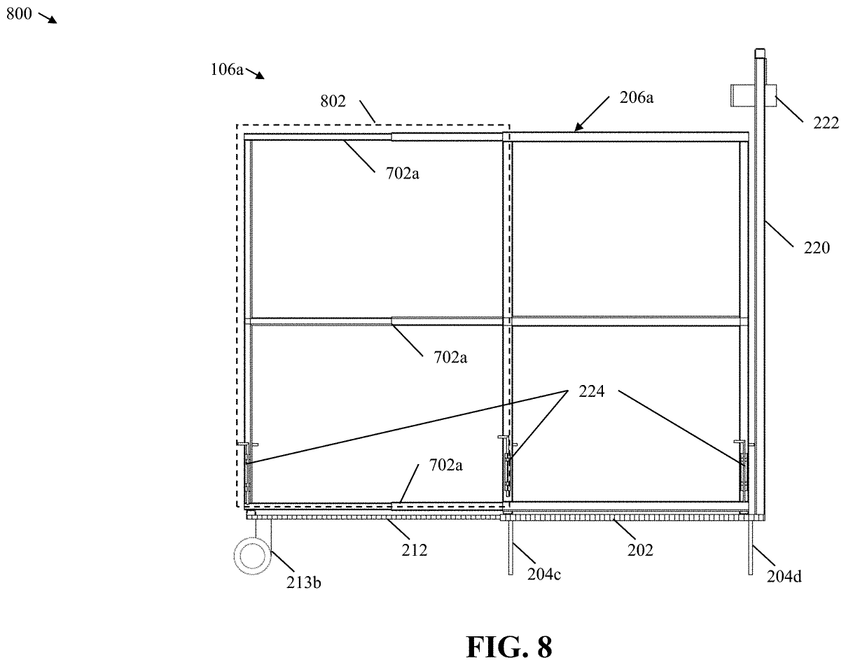

Further, the first support unit 214a is coupled to the first multi-tier structure 206a by way of a first set of linking members (shown in FIG. 7). In other words, the first support unit 214a is linked to the first multi-tier structure 206a by way of the first set of linking members. In one embodiment, the first set of linking members includes a first set of telescopic foldable tubes. The first set of linking members may be mounted on one end of the first multi-tier structure 206a (e.g., the end that is proximate to the first support unit 214a). The first set of linking members (e.g., the first set of telescopic foldable tubes) may be extendable (and retractable/collapsible) along the “Y” axis. The first set of linking members extends or collapses based on a movement of the second base plate 212 along the “Y” axis. In other words, the first set of linking members may be moved between a fully retracted (e.g., fully collapsed) and a fully extended (e.g., expanded) state. When the first set of linking members is fully extended (e.g., when the second base plate 212 is at the fourth position), the first support unit 214a and the first set of linking members collectively form a second multi-tier structure (shown in FIG. 8). Extension and retraction of the first set of linking members is explained in conjunction with FIGS. 7 and 8.

In one embodiment, the first movable operator station 106a further includes a third multi-tier structure 206b and a second support unit 214b. The third multi-tier structure 206b and the second support unit 214b may be structurally and functionally similar to the first multi-tier structure 206a and the first support unit 214a. The third multi-tier structure 206b is slidably coupled to the first base plate 202 by way of a fourth set of sliding members (e.g., guides rails; shown in FIG. 12) mounted on the top surface of the first base plate 202. The third multi-tier structure 206b is slidable along the “X” axis between a seventh position and an eighth position. The seventh position and the eighth position of the third multi-tier structure 206b may be analogous to the first position and the second position, respectively, of the first multi-tier structure 206a.

The second support unit 214b is slidably coupled to the second base plate 212 by way of a fifth set of sliding members (e.g., guides rails; shown in FIG. 12) mounted on the top surface of the second base plate 212. The second support unit 214b is slidable along the “X” axis between a ninth position and a tenth position. The ninth position and the tenth position may be analogous to the fifth position and the sixth position, respectively, of the first support unit 214a.

The third multi-tier structure 206b may be coupled to the second support unit 214b by way of a second set of linking members (e.g., telescopic foldable tubes; shown in FIG. 7). In other words, the second set of linking members links the third multi-tier structure 206b to the second support unit 214b. The second set of linking members may be structurally and functionally similar to the first set of linking members.

The second set of linking members extends (e.g., expands) or collapses (e.g., retracts) based on a movement (e.g., sliding movement) of the second base plate 212 between the third position and the fourth position along the “Y” axis. The second set of linking members collapses when the second base plate 212 is at the third position, while the second set of linking members is fully extended when the second base plate 212 is at the fourth position. FIG. 2 illustrates a scenario in which the second base plate 212 is at the third position (i.e., the second set of linking members is in a collapsed state). When the second base plate 212 is at the fourth position (i.e., the second set of linking members is in a fully extended state), the second set of linking members and the second support unit 214b form a fourth multi-tier structure. In other words, the second support unit 214b is slidable along the “X” axis in conjunction with the third multi-tier structure 206b such that the second support unit 214b and the second set of linking members form the fourth multi-tier structure when the second base plate 212 is at the fourth position. Structure and functionality of the second set of linking members is described in conjunction with FIG. 7.

It will be apparent to those of skill in the art that the first movable operator station 106a may not necessarily include multiple multi-tier structures (e.g., the third multi-tier structure 206b), multiple support units (e.g., the second support unit 214b), or multiple sets of linking members (e.g., the second set of linking members). In one embodiment, the first movable operator station 106a may include only a single multi-tier structure (e.g., the first multi-tier structure 206a), a single support unit (e.g., the first support unit 214a), and a single set of linking members (e.g., the first set of linking members) without deviating from the scope of the disclosure.

The first movable operator station 106a further includes a vertical frame 220 (e.g., an upright frame) that is attached to one end of the first base plate 202 and oriented parallel to “XZ” plane. In one embodiment, mounted on top of the vertical frame 220 is an imaging device 222 that is configured to provide a set of visual cues to an operator (e.g., a human operator or a robotic operator) performing pick and/or put operations at the first movable operator station 106a. For example, when an item (e.g., apparel) is to be picked (e.g., pick operation) from the first movable operator station 106a and placed in a nearby storage unit, the imaging device 222 may, based on a set of instructions received from the control server 108, project a beam of light on the item that is to be picked from the first movable operator station 106a. The operator may, based on the projected beam of light, pick the item from the first movable operator station 106a and place it in the nearby storage unit. In another example, when an item (e.g., apparel) is to be picked (e.g., pick operation) from a nearby storage unit and placed in the first movable operator station 106a (e.g., put operation) and placed in a nearby storage unit, the imaging device 222 may, based on a set of instructions received from the control server 108, project a beam of light on a designated location, in the first movable operator station 106a, at which the item is to be placed. The operator may, based on the projected beam of light, pick the item from the nearby storage unit and place it at the designated location, based on the projected beam of light. In one embodiment, a wavelength of the projected beam of light may differ based on a type of operation that is to be performed. For example, the projected beam of light may correspond to a first wavelength or a first color (e.g., green) when a pick operation is to be performed by the operator. Similarly, the projected beam of light may correspond to a second wavelength or a second color (e.g., blue) when a put operation is to be performed by the operator. Further, the wavelength of the projected beam of light may differ based on a priority level of an operation that is to be performed by the operator. For example, when an operation (e.g., a pick operation, a put operation, or the like) that is to be performed by the operator corresponds to a first priority level (e.g., a high priority level), the projected beam of light may correspond to a first wavelength or a first color (e.g., red). Similarly, when an operation (e.g., a pick operation, a put operation, or the like) that is to be performed by the operator corresponds to a second priority level (e.g., a low priority level), the projected beam of light may correspond to a second wavelength or a second color (e.g., yellow).

In a current embodiment, the imaging device 222 may project a beam of light on an item or on a designated location in the first movable operator station 106a, based on a type (e.g., a pick operation, a put operation, or the like) of operation that is to be performed by the operator. In an actual implementation, the imaging device 222 may, based on the set of instructions received from the control server 108, project the beam of light on any object or location (e.g., a floor) that is within a threshold distance of the operator.

In one embodiment, the first movable operator station 106a may further include the display screen (not shown) that is communicably coupled (e.g., by way of the communication network 110) to the control server 108. The display screen may be configured to display one or more instructions for the operator. The one or more instructions may be received from the control server 108 and may be indicative of one or more operations (e.g., pick and/or put operations) to be performed by the operator at the first movable operator station 106a. The operator at the first movable operator station 106a may perform the one or more operations based on the one or more instructions displayed on the display screen.

In one embodiment, one or more structures (e.g., the first and third multi-tier structures 206a-206b and the first and second support units 214a and 214b) included in the first movable operator station 106a may have latches (e.g., a set of latches 224) installed, thereon. The set of latches 224 enable the first and third multi-tier structures 206a-206b and the first and second support units 214a and 214b to be locked in position (e.g., the first position, the second positions, or the like) with respect to a corresponding base plate (e.g., the first and second base plates 202 and 212). In other words, the set of latches 224 when engaged prevent unintended movement of the one or more structures (e.g., the first and third multi-tier structures 206a-206b and the first and second support units 214a and 214b). The set of latches 224 may be disengaged when the one or more structures are to be moved

In one embodiment, each sliding member of the first through fifth sets of sliding members may include one or more stoppers (not shown) to restrict a movement of a structure (e.g., the first and third multi-tier structures 206a-206b, the first and second support units 214a and 214b, and the second base plate 212) mounted on a corresponding set of sliding members.

Referring now to FIG. 3, since the second base plate 212 is in the third position, the first set of linking members is in the collapsed state. Therefore, the first support unit 214a and the first set of linking members do not currently form the second multi-tier structure. Further, the first support unit 214a is in the fifth position.

Referring now to FIG. 5, since the second base plate 212 is in the third position, only a small portion of the first base plate 202 is visible in the bottom view. FIG. 5 further illustrates the second set of sliding members (e.g., first and second sliding members 502a and 502b). Hereinafter, the second set of sliding members is designated and referred to as “the second set of sliding members 502”. In the current embodiment, the second set of sliding members 502 is shown to include two guide rails or sliding members (e.g., the first and second sliding members 502a and 502b). It will be apparent to those of skill in the art that in an actual implementation the second set of sliding members 502 may include any number of sliding members or guide rails without deviating from the scope of the disclosure. The identification marker (e.g., barcode, QR code, or the like) of the first movable operator station 106a is shown to be attached to the bottom surface of the second base plate 212. Hereinafter, the identification marker of the first movable operator station 106a is designated and referred to as “the identification marker 504”.

A position of the identification marker 504, with respect to the first base plate 202, may change when the second base plate 212 is slid to from the third position to the fourth position. In another embodiment, the first movable operator station 106a may further include a third base plate (not shown) that is attached to the first base plate 202 but is located underneath the second base plate 212. The third base plate may remain stationary with respect to the first base plate 202 irrespective of a position of the second base plate 212. In such a scenario, the identification marker 504 may be attached or affixed to a bottom surface of the third base plate to ensure that the position of the identification marker 504 remains constant irrespective of a position of the second base plate 212.

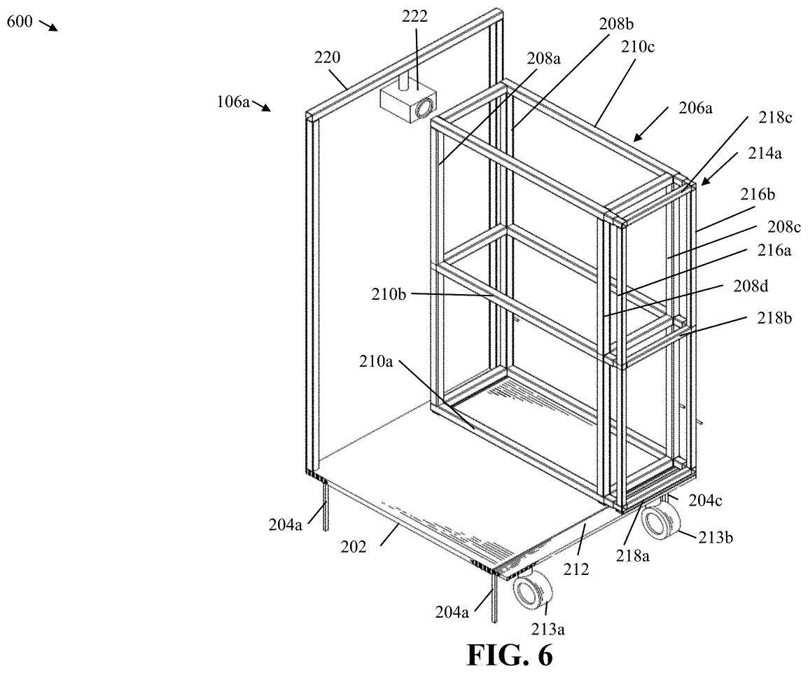

FIG. 6 is a diagram 600 that illustrates a perspective view of the first movable operator station 106a, in accordance with another exemplary embodiment of the disclosure. FIG. 6 is explained in conjunction with FIG. 2.

FIG. 6 illustrates a scenario in which the first movable operator station 106a includes only a single multi-tier structure (e.g., the first multi-tier structure 206a), a single support unit (e.g., the first support unit 214a), and a single set of linking members (e.g., the first set of linking members).

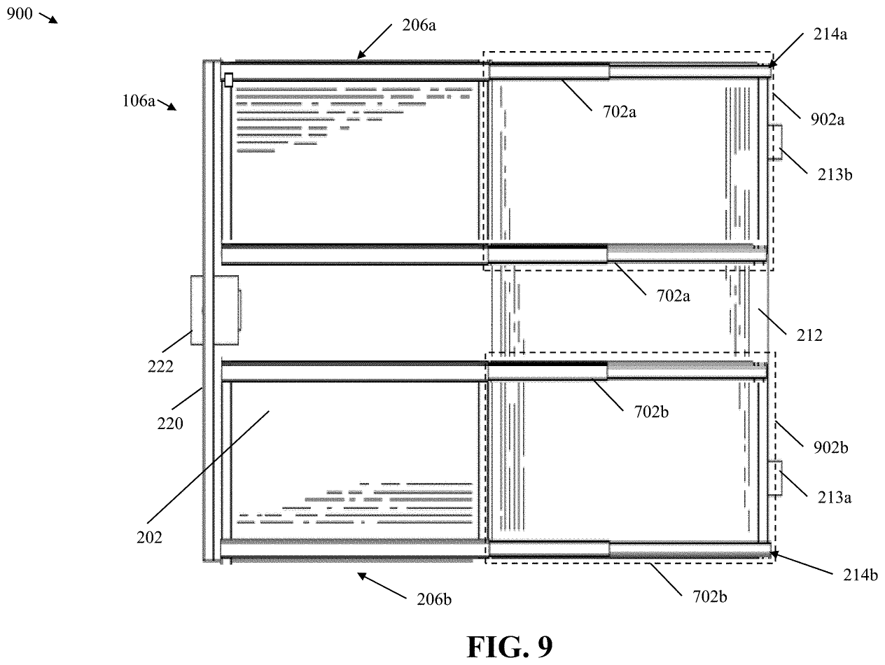

FIG. 7 is a diagram 700 that illustrates a perspective view of the first movable operator station 106a when the second base plate 212 is extended along the “Y” axis, in accordance with an exemplary embodiment of the disclosure. FIG. 7 is explained in conjunction with FIG. 2. FIGS. 8, 9, and 10 are explained in conjunction with FIG. 7. FIG. 8 is a diagram 800 that illustrates a side view of the first movable operator station 106a when the second base plate 212 is extended along the “Y” axis, in accordance with an exemplary embodiment of the present disclosure. FIG. 9 is a diagram 900 that illustrates a top view of the first movable operator station 106a when the second base plate 212 is extended along the “Y” axis, in accordance with an exemplary embodiment of the present disclosure. FIG. 10 is a diagram 1000 that illustrates a bottom view of the first movable operator station 106a when the second base plate 212 is extended along the “Y” axis, in accordance with an exemplary embodiment of the present disclosure.

Referring now to FIG. 7, described is a scenario in which the second base plate 212 is slid from the third position to the fourth position by way of the second set of sliding members 502 and the set of wheels 213.

The first set of linking members (e.g., the first set of telescopic foldable tubes) extend or expand when the second base plate 212 is slid from the third position to the fourth position. Hereinafter, the first set of linking members is designated and referred to as “the first set of linking members 702a” (shown in FIGS. 8 and 9). To avoid cluttering the diagram, only the first set of linking members 702a at the top level are labeled. The first set of linking members 702a at the middle level and the base level are labeled in FIG. 8.

Referring now to FIG. 8, the first set of linking members 702a (e.g., the first set of telescopic foldable tubes) is shown to be fully extended (e.g., fully expanded) when the second base plate 212 is at the fourth position. The first set of linking members 702a at the base level, the middle level, and the top level is also shown. Also shown is the second multi-tier structure (shown by dotted box 802) formed by the first set of linking members 702a and the first support unit 214a when the second base plate 212 is at the fourth position.

Referring back to FIG. 7, the first multi-tier structure 206a is shown to be at the first position and the first support unit 214a is shown to be at the fifth position. Similarly, when the second base plate 212 is slid from the third position to the fourth position, the second set of linking members (e.g., the second set of telescopic foldable tubes) extend or expand. Hereinafter, the second set of linking members is designated and referred to as “the second set of linking members 702b”. When the second base plate 212 is at the fourth position, the second set of linking members 702b is fully extended (e.g., in a fully extended state, as shown in FIG. 7). When the second set of linking members 702b is fully extended or expanded, the second set of linking members 702b (e.g., the second set of foldable telescopic tubes) and the second support unit 214b collectively form the fourth multi-tier structure (shown in FIG. 9).

Referring to FIG. 9, since the second base plate 212 is at the fourth position, the first set of linking members 702a and the second set of linking members 702b are shown to be fully extended (e.g., fully expanded). The first multi-tier structure 206a and the first support unit 214a are shown to be at the first position and the fifth position, respectively. Similarly, the third multi-tier structure 206b and the second support unit 214b are shown to be at the seventh position and the ninth position, respectively. The second multi-tier structure, formed by the first set of linking members 702a and the first support unit 214a when the second base plate 212 is at the fourth position, is shown by dotted box 902a. The fourth multi-tier structure, formed by the second set of linking members 702b and the second support unit 214b when the second base plate 212 is at the fourth position, is shown by dotted box 902b.

To avoid clutter in the FIGS. 7-10, the first plurality of posts 208, the first plurality of separators 210, the second plurality of posts 216, and the second plurality of separators 218 are not labeled.

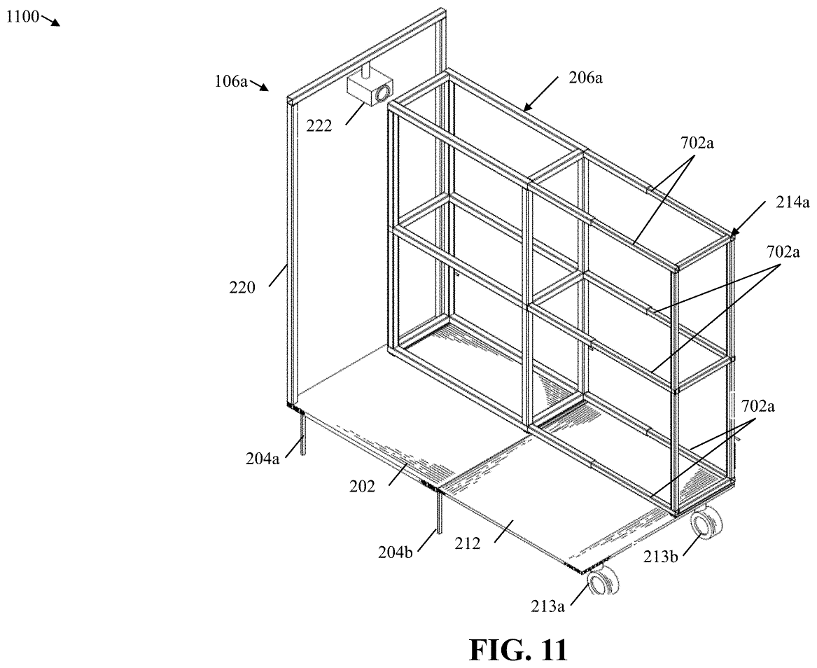

FIG. 11 is a diagram 1100 that illustrates a perspective view of the first movable operator station 106a when the second base plate 212 is extended along the “Y” axis, in accordance with another exemplary embodiment of the disclosure. FIG. 11 is explained in conjunction with FIG. 7.

FIG. 11 illustrates a scenario in which the first movable operator station 106a includes only a single multi-tier structure (e.g., the first multi-tier structure 206a), a single support unit (e.g., the first support unit 214a), and a single set of linking members (e.g., the first set of linking members 702a).

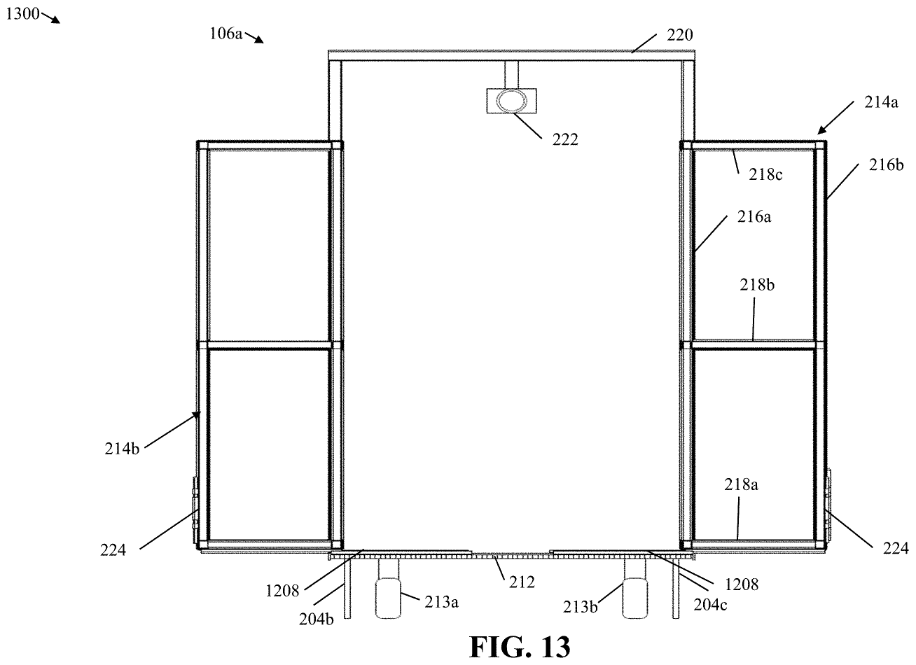

FIG. 12 is a block diagram 1200 that illustrates a perspective view of the first movable operator station 106a when the first multi-tier structure 206a is extended along the “X” axis and the second base plate 212 is extended along the “Y” axis, in accordance with an exemplary embodiment of the disclosure. FIG. 12 is explained in conjunction with FIG. 7. FIG. 13 is explained in conjunction with FIG. 12. FIG. 13 is a block diagram 1300 that illustrates a front view of the first movable operator station 106a when the first multi-tier structure 206a is extended along the “X” axis and the second base plate 212 is extended along the “Y” axis, in accordance with an exemplary embodiment of the disclosure.

Referring now to FIG. 12, illustrated a scenario in which the second base plate 212 is in the fourth position, the first multi-tier structure 206a is in the second position, the first support unit 214a is in the sixth position, the third multi-tier structure 206b is in the eighth position, and the second support unit 214b is in the tenth position.

The first multi-tier structure 206a may be slid from the first position to the second position by way of the first set of sliding members. In a non-limiting example, the first set of sliding members is shown to include third and fourth sliding members (e.g., guide rails) 1202a and 1202b (i.e., two sliding members). However, in an actual implementation, the first set of sliding members may include any number of sliding members or guide rails without deviating from the scope of the disclosure. Hereinafter, the first set of sliding members is designated and referred to as “the first set of sliding members 1202”.

Similarly, the first support unit 214a may be slid from the fifth position to the sixth position by way of the third set of sliding members. In a non-limiting example, the third set of sliding members is shown to include a fifth sliding member (e.g., guide rail) 1204 (i.e., a single sliding member). However, in an actual implementation, the third set of sliding members may include any number of sliding members or guide rails without deviating from the scope of the disclosure. Hereinafter, the third set of sliding members is designated and referred to as “the third set of sliding members 1204”.

Since the first multi-tier structure 206a and the first support unit 214a are linked by way of the first set of linking members 702a, the first multi-tier structure 206a and the first support unit 214a slide (e.g., move) in tandem from the first position to the second position and from the fifth position to the sixth position, respectively. When the first multi-tier structure 206a is slid from the first position to the second position, the first support unit 214a slides from the fifth position to the sixth position in conjunction with the first multi-tier structure 206a. The first support unit 214a is slidable along the “X” axis in conjunction with the first multi-tier structure 206a. The first support unit 214a and the first set of linking members 702a form the second multi-tier structure when the second base plate 212 is at the fourth position.

The third multi-tier structure 206b may be slid from the seventh position to the eighth position by way of the fourth set of sliding members. In a non-limiting example, the fourth set of sliding members is shown to include sixth and seventh sliding members (e.g., guide rails) 1206a and 1206b (i.e., two sliding members). However, in an actual implementation, the fourth set of sliding members may include any number of sliding members or guide rails without deviating from the scope of the disclosure. Hereinafter, the fourth set of sliding members is designated and referred to as “the fourth set of sliding members 1206”.

Similarly, the second support unit 214b may be slid from the ninth position to the tenth position by way of the fifth set of sliding members. In a non-limiting example, the fifth set of sliding members is shown to include an eighth sliding member (e.g., guide rail) 1208 (i.e., a single sliding member). However, in an actual implementation, the fifth set of sliding members may include any number of sliding members or guide rails without deviating from the scope of the disclosure. Hereinafter, the fifth set of sliding members is designated and referred to as “the fifth set of sliding members 1208”.

Since the third multi-tier structure 206b and the second support unit 214b are linked by way of the second set of linking members 702b, the third multi-tier structure 206b and the second support unit 214b slide (e.g., move) in tandem from the seventh position to the eighth position and from the ninth position to the tenth position, respectively. Therefore, when the third multi-tier structure 206b is slid from the seventh position to the eighth position, the second support unit 214b slides from the ninth position to the tenth position in conjunction with the third multi-tier structure 206b. The second support unit 214b is slidable along the “X” axis in conjunction with the third multi-tier structure 206b. The second support unit 214b and the second set of linking members 702b form the fourth multi-tier structure when the second base plate 212 is at the fourth position.

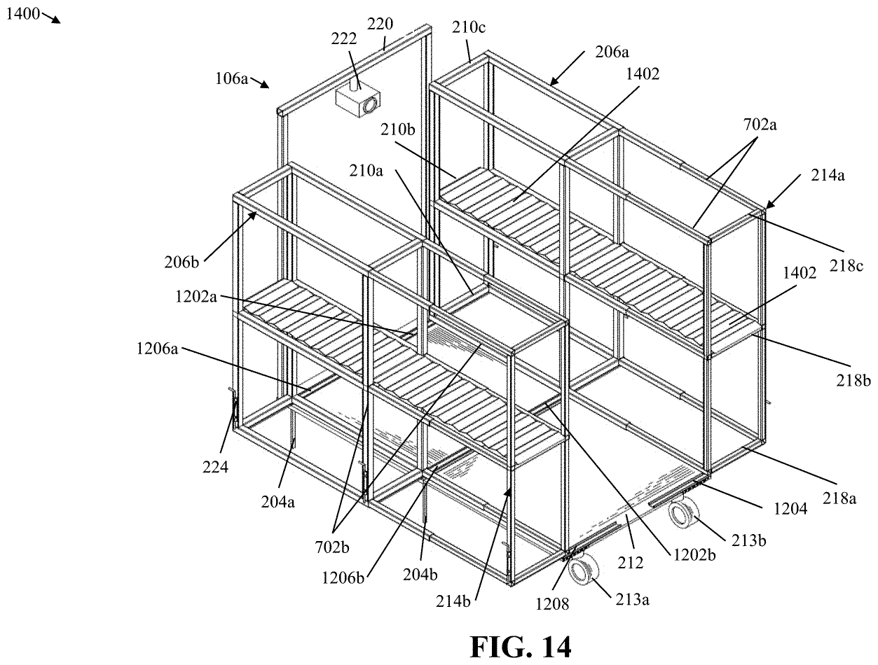

FIG. 14 is a diagram 1400 that illustrates a perspective view of the first movable operator station 106a when the first multi-tier structure 206a is extended along the “X” axis and the second base plate 212 is extended along the “Y” axis, in accordance with another exemplary embodiment of the disclosure. FIG. 14 is described in conjunction with FIG. 12.

Illustrated in FIG. 14 is a perspective view of the first movable operator station 106a when the second base plate 212 is in the fourth position, the first multi-tier structure 206a is in the second position, the first support unit 214a is in the sixth position, the third multi-tier structure 206b is in the eighth position, and the second support unit 214b is in the tenth position. Further, FIG. 14 illustrates a scenario in which a storage mechanism (e.g., storage shelves) are included in the first and third multi-tier structures 206a and 206b and the third and fourth multi-tier structures. For the sake of brevity, a storage mechanism (e.g., a storage shelf) is shown to be included only in the middle level of the first and third multi-tier structures 206a and 206b and the third and fourth multi-tier structures. However, it will be apparent to those of skill in the storage mechanism or the storage shelves may be included in other levels (e.g., the base level and the top level) without deviating from the scope of the disclosure.

A first storage shelf 1402 is shown to be included or formed in the middle level of the first multi-tier structure 206a and the second multi-tier structure. In a non-limiting example, the first storage shelf 1402 may be formed by installing a supporting structure (e.g., planks or slabs) on the first plurality of separators 210 and the second plurality of separators 218 at the middle level. The supporting structure may be permanently or temporarily installed. For example, the supporting structure may be installed on the first plurality of separators 210 and the second plurality of separators 218, as a permanent fixture (e.g., permanently installed). Alternatively, the supporting structure may be manually and temporarily placed on the first plurality of separators 210 and the second plurality of separators 218 (e.g., temporarily installed).

A type and a material of the supporting structure may vary without deviating from the scope of the disclosure. Further, different types of supporting structures may be simultaneously installed on the first plurality of separators 210 and the second plurality of separators 218 without deviating from the scope of the disclosure.

In one embodiment, a supporting structure may be installed on the second plurality of separators 218 may be configured to extend (e.g., expand) or retract (e.g., collapse) based on a movement of the second base plate 212 along the “Y” axis between the third and fourth positions. For example, a collapsible fabric material may be installed on the second plurality of separators 218. The cloth bag may extend or retract (e.g., collapse) in conjunction with the first set of linking members 702a (i.e., based on the movement of the second base plate 212 between the third and fourth positions). When the second base plate 212 is slid to the fourth position, the cloth bag extends (e.g., expands or unfurls) in conjunction with the first set of linking members 702a. When the second base plate 212 is slid to the third position, the cloth bag collapses in conjunction with the first set of linking members 702a

In another embodiment, a set of bags (e.g., tote bags) may be attached, by way of hooks (not shown) to the first plurality of separators 210 and the second plurality of separators 218. In such a scenario, inventory items may be stored (e.g., temporarily stored) in the set of bags.

It will be apparent to those of skill in the art that shelves or storage mechanisms may be installed in the third multi-tier structure 206b and the fourth multi-tier structure in a similar manner.

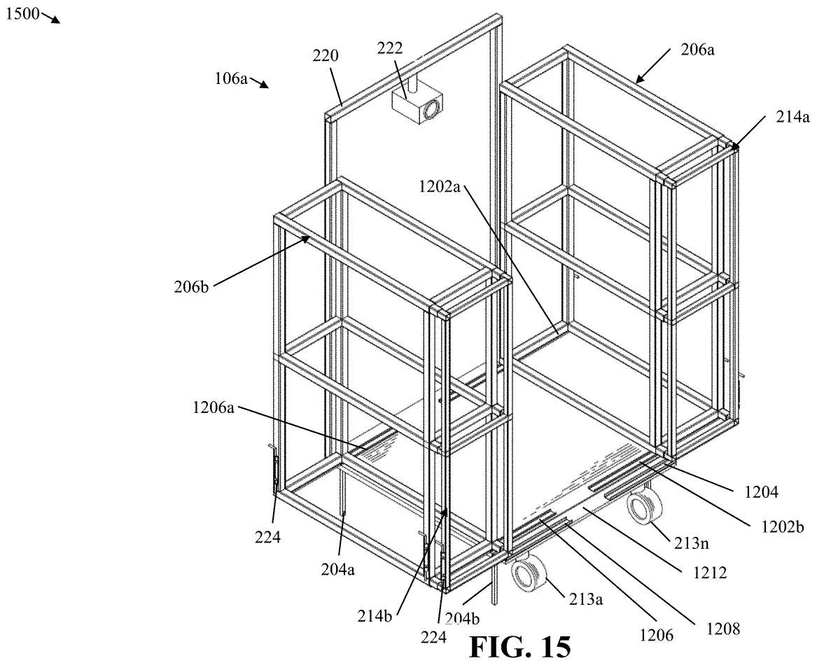

FIG. 15 is a diagram 1500 that illustrates a perspective view of the first movable operator station 106a when the first multi-tier structure 206a is extended along the “X” axis and the second base plate 212 is retracted along the “Y” axis, in accordance with an exemplary embodiment of the disclosure.

Illustrated in FIG. 15 is a scenario in which the second base plate 212 is at the fourth position, the first multi-tier structure 206a is at the second position, the first support unit 214a is at the sixth position, the third multi-tier structure 206b is at the eighth position, and the second support unit 214b is at the tenth position. The second base plate 212 is slid from the fourth position to the third position by way of the second set of sliding members 502 and the set of wheels 213.

The first set of linking members 702a (e.g., the first set of telescopic foldable tubes) and the second set of linking members 702b (e.g., the second set of telescopic foldable tubes) collapse when the second base plate 212 is slid from the fourth position to the third position along the “Y” axis. In other words, the first set of linking members 702a and the second set of linking members 702b are in the collapsed state when the second base plate 212 is at the third position.

FIGS. 2-15 illustrate the first multi-tier structure 206a as a rigid structure. In other words, the first through fourth posts 208a-208d are shown to form a rigid frame. However, in another embodiment, the first and second posts 208a and 208b may be connected to the third and fourth posts 208c and 208d by way of a set of linking members (e.g., a third set of linking members; not shown). For example, the first and second posts 208a and 208b may be connected to the third and fourth posts 208c and 208d by way of a third set of foldable telescopic tubes. In such a scenario, the third and fourth posts 208c and 208d may be slotted into a sixth set of sliding members (e.g., guide rails; not shown) mounted on the top surface of the first base plate 202. The third and fourth posts 208c and 208d may be configured to slide, in tandem along the “Y” axis with respect to the first base plate 202, by way of the sixth set of sliding members. The third set of linking members may extend or collapse (e.g., retract) based on a movement of the third and fourth posts 208c and 208d along the “Y” axis (e.g., away from or towards the first and second posts 208a and 208b). This allows for a more compact design for the first movable operator station 106a.

FIGS. 2-15 describe a structure and functionality of the first movable operator station 106a. However, it will be apparent to those of skill in the art that the second through n^{th} movable operator stations 106b-106n may be structurally similar to the first movable operator station 106a, but necessarily same as the first movable operator station 106a. For example, a count of multi-tier structures, a count of support units, a count of support frames, a count of sliding members, a count of linking members, or the like may vary for each of the second through n^{th} movable operator stations 106b-106n without deviating from the scope of the disclosure. Similarly, location of multi-tier structures, location of support units, location of support frames, location and length of sliding members, location and length of linking members, or the like may vary for each of the second through n^{th} movable operator stations 106b-106n without deviating from the scope of the disclosure.

FIG. 16 is a diagram 1600 that illustrates the control server 108, in accordance with an exemplary embodiment of the present disclosure. In some embodiments, the control server 108 may include processing circuitry 1602, a memory 1604, and a transceiver 1606. The processing circuitry 1602, the memory 1604, and the transceiver 1606 may communicate with each other by way of a communication bus 1608. The processing circuitry 1602 may include an operations management engine 1610 and an image processor 1612. It will be apparent to a person having ordinary skill in the art that the control server 108 is for illustrative purposes and not limited to any specific combination of hardware circuitry and/or software.

The processing circuitry 1602 includes suitable logic, instructions, circuitry, interfaces, and/or code for executing various operations, such as inventory or warehouse management operations. The processing circuitry 1602 may be configured to receive requests (e.g., order requests, inventory replenishment requests, or the like) and execute corresponding operations for fulfilment of the received requests. The processing circuitry 1602 may be further configured to optimize operational efficiency of the storage facility 102 by determining a location, in the storage facility 102, for installation of each of the set of movable operator stations 106. Further, the processing circuitry 1602 facilitates transportation of storage units and movable operator stations (e.g., the set of movable operator stations 106). The processing circuitry 1602 executes various operations by way of the operations management engine 1610 and the image processor 1612.

Examples of the processing circuitry 1602 may include, but are not limited to, an application-specific integrated circuit (ASIC) processor, a reduced instruction set computing (RISC) processor, a complex instruction set computing (CISC) processor, a field-programmable gate array (FPGA), a microcontroller, a combination of a central processing unit (CPU) and a graphics processing unit (GPU), or the like.

The memory 1604 includes suitable logic, instructions, circuitry, interfaces to store one or more instructions that are executed by the processing circuitry 1602 for performing one or more operations. Additionally, the memory 1604 may store, therein, the virtual map of the storage facility 102, an inventory list associated with the storage facility 102, operations metrics corresponding to operation of the storage facility 102, historical data associated with the operation of the storage facility 102, or the like. The operations metrics may include data such as, but not limited to, a health of each of the set of AGVs 104, details of operations being performed by each of the set of AGVs 104, a level of throughput of each operator at each movable operator station (e.g., the set of movable operator stations 106), a level of throughput of each of the set of movable operator stations 106, or the like.

In a non-limiting example, the memory 1604 stores the virtual map (hereinafter, “the virtual map 1614a”) that is indicative of a layout (e.g., top view) of the storage facility 102 at a first time-instance. The first time-instance may refer to a time-instance at which the first movable operator station 106a is at the current location of the first movable operator station 106a. For the sake of brevity, the virtual map 1614a is indicative of locations of only the first movable operator station 106a and the second movable operator station 106b. It will apparent to those of skill in the art that, in an actual implementation, the virtual map 1614a may be indicative of locations of other operator stations of the set of movable operator stations 106, locations of the set of AGVs 104, locations of the plurality of storage units, or the like. The virtual map 1614a is shown to indicate a set of locations (e.g., “L₁”, “L₂”, “L₃”; the first set of locations) available at the first time-instance for the installation of the first movable operator station 106a. In a non-limiting example, “L₁” is the first location determined for the installation of the first movable operator station 106a. The virtual map 1614a may be updated following the transportation of the first movable operator station 106a, from the current location of the first movable operator station 106a, to the first location “L₁”. Hereinafter, the updated virtual map is referred to as “the updated virtual map 1614b”. The updated virtual map 1614b indicates that the first movable operator station 106a is now installed at the first location “L₁”. The updated virtual map 1614b further indicates that the location vacated by the first movable operator station 106a is now available (e.g., “L₄”).

Examples of the memory 1604 may include a RAM, a ROM, a removable storage drive, an HDD, a flash memory, a solid-state memory, and the like.

The operations management engine 1610 is configured to receive operations data (e.g., the operations metrics) that pertain to the operation of the storage facility 102. The operations data may be received from various devices or components (e.g., sensors, processors, or the like) that are configured to measure a performance of each of the set of AGVs 104, the set of movable operator stations 106, or the like. For example, the operations management engine 1610 may be configured to receive, from one or more devices or sensors, data indicative of a number of pick/put operations performed per unit time (e.g., the current level of throughput) at the first movable operator station 106a. The operations (e.g., the operations metrics) may be indicative of an operational health and/or an operational efficiency of the storage facility 102 as a whole. The operations management engine 1610 may store the received operations data (e.g., the operations metrics) in the memory 1604.

Based on the operations data (e.g., the operations metrics), the operations management engine 1610 may execute and/or facilitate one or more operations for improving an efficiency of operations at the storage facility 102. For example, as described in the foregoing description of FIG. 1, the operations management engine 1610 may, based on the current level of throughput of the first movable operator station 106a, facilitate the installation of the first movable operator station 106a at the first location. The operations management engine 1610 may communicate a set of instructions to the first AGV 104a (as shown in FIG. 16) to transport the first movable operator station 106a from the current location of the first movable operator station 106a to the first location (as described in the foregoing description of FIG. 1).

The image processor 1612 may be configured to perform one or more operations, which correspond to image processing, for facilitating pick and/or put operations by the operator (e.g., human or robotic operator) at the first movable operator station 106a. The image processor 1612 may receive, from the imaging device 222 in real-time or near real-time, a set of images of inventory items and/or empty spaces present in the first and third multi-tier structures 206a and 206b and the third and fourth multi-level structures. Based on the received set of images and requests (e.g., order requests, or the like), the image processor 1612 may determine or identify a set of inventory items in the first movable operator station 106a that are to be picked up (e.g., pick operation) by the operator for fulfilling the requests. Similarly, based on the received set of images and requests (e.g., inventory replenishment requests), the image processor 1612 may determine or identify a set of empty spaces available in the first movable operator station 106a for temporary storage (e.g., put operation).

Based on the determined/identified set of inventory items and empty spaces, the image processor 1612 may communicate, to the imaging device 222, one or more instructions or commands to facilitate the pick and/or put operations by the operator at the first movable operator station 106a. The imaging device 222 may provide a set of visual cues to the operator based on the received one or more instructions and/or commands. For example, the imaging device 222 may project a beam of light of a first color on a first inventory item stored in the first movable operator station 106a to indicate that the first inventory item is to be picked up (e.g., pick operation) by the operator and placed in a nearby storage unit for order fulfilment. Similarly, the imaging device 222 may project a beam of light of a second color on an empty space (e.g., in the first multi-tier structure 206a) in the first movable operator station 106a to indicate that a second inventory item picked from the nearby storage unit, by the operator, is to be placed temporarily in the empty space for a purpose of inventory replenishment.

The transceiver 1606 transmits and receives data over the communication network 110 using one or more communication network protocols. The transceiver 1606 may transmit various messages and commands to the set of AGVs 104, one or more devices (e.g., electronic devices or components such as the imaging device 222) associated with the set of movable operator stations 106 and receive data from the set of AGVs 104 and the one or more devices associated with the set of movable operator stations 106. Examples of the transceiver 1606 may include, but are not limited to, an antenna, a radio frequency transceiver, a wireless transceiver, a Bluetooth transceiver, an ethernet based transceiver, a universal serial bus (USB) transceiver, or any other device configured to transmit and receive data.

In one embodiment, a movement (e.g., sliding movement) of the structures (e.g., the first and third multi-tier structures 206a and 206b, the first and second support units 214a and 214b, the second base plate 212, or the like) may be electronically controlled. In such a scenario, the first movable operator station 106a may include a set of electronic, electrical, and/or electromechanical components (e.g., sensors, motors, actuators, or the like) communicably coupled to the control server 108. The control server 108 may communicate instructions and/or commands to the set of electronic, electrical, and/or electromechanical components to control the movement of the structures. For example, the control server 108 may communicate a first instruction to the set of electronic, electrical, and/or electromechanical components to slide the first multi-tier structure 206a to the second position from the first position.

In one embodiment, movement (e.g., sliding movement) of various structures (e.g., the first multi-tier structure 206a, the third multi-tier structure 206b, the second base plate 212, the first support unit 214a, the second support unit 214b, or the like) may take place simultaneously. For example, the control server 108 may communicate one or more instructions to the set of electronic, electrical, and/or electromechanical components to, simultaneously, slide the first multi-tier structure 206a to the second position from the first position and the third multi-tier structure 206b to the eighth position from the seventh position. Based on the received one or more instructions, the first multi-tier structure 206a and the third multi-tier structure 206b may be slidably moved (e.g., slid) to the second position and the eighth position, respectively. Similarly, based on the one or more instructions, the set of electronic, electrical, and/or electromechanical components may move (e.g., slidably move) the second base plate 212 to the fourth position from the third position (or vice-versa), in conjunction with the movement of the first multi-tier structure 206a and the third multi-tier structure 206b to the second position and the eighth position, respectively. In other words, the various structures may be moved (e.g., slidably moved) between various corresponding positions (e.g., first and second positions, third and fourth positions, or the like) simultaneously without deviating from the scope of the disclosure.

FIGS. 17A and 17B, collectively represent a flow chart 1700 that illustrates a process (i.e., a method) for implementing dynamic workstations, in accordance with an exemplary embodiment of the disclosure. FIGS. 17A and 17B have been explained in conjunction with FIGS. 1-16.

Referring now to FIG. 17A, the process may generally start at step 1702, where the control server 108 may receive the operations data (e.g., the operations metrics) corresponding to the operation of the storage facility 102. The process proceeds to step 1704, where the control server 108, based on the received operations data, determines the current level of throughput of the first movable operator station 106a. The process proceeds to step 1706, the control server 108 determines whether the current level of throughput of the first movable operator station 106a is greater than or equal to the designated threshold. If at step 1706, the control server 108 determines that the current level of throughput of the first movable operator station 106a is greater than or equal to the designated threshold, the process proceeds to step 1702. If at step 1706, the control server 108 determines that the current level of throughput of the first movable operator station 106a is not greater than or equal to the designated threshold, the process proceeds to step 1708. In other words, if the control server 108 determines that the current level of throughput of the first movable operator station 106a is less than the designated threshold, the process proceeds to step 1708. At step 1708, the control server 108 determines the current level of availability (e.g., occupied, empty, soon to be vacated, soon to be occupied, or the like) of the plurality of locations in the storage facility 102. The control server 108 determines the current level of availability of the plurality of locations further based on the determination that the current location of the first movable operator station 106a is negatively affecting the current level of throughput of the first movable operator station 106a (as described in the foregoing description of FIG. 1).

Referring now to FIG. 17B, the process proceeds to step 1710, where the control server 108 determines the first set of locations. The first set of locations may include one or more locations, of the plurality of locations, that are currently available (and/or soon to be available). The process proceeds to step 1712, where the control server 108 determines (e.g., estimates), for each of the first set of locations, a level of throughput (e.g., an expected level of throughput) of the first movable operator station 106a at a corresponding location. The process proceeds to step 1714, where the control server 108 determines the second set of locations, based on the determined level of throughput of the first movable operator station 106a at each of the first set of locations. The second set of locations includes one or more locations for which the determined level of throughput of the first movable operator station 106a at a corresponding location is greater than or equal to the designated threshold. The process proceeds to step 1716, where the control server 108 determines (e.g., selects), based on the determined second set of locations, a location (e.g., the first location) for the installation of the first movable operator station 106a. The process proceeds to step 1718, where the control server 108 communicates a set of instructions to the first AGV 104a to transport the first movable operator station 106a to the first location from the current location of the first movable operator station 106a. The set of instructions is indicative of the first route to be followed by the first AGV 104a to reach the current location of the first movable operator station 106a from the current location of the first AGV 104a. The set of instructions is further indicative of the second route to be followed by the first AGV 104a from the current location of the first movable operator station 106a to the first location for the installation of the first movable operator station 106a. The set of instructions is further indicative of the identification marker 504 of the first movable operator station 106a. Based on the set of instructions, the first AGV 104a transports the first movable operator station 106a to the first location, thereby installing the first movable operator station 106a at the first location. Consequently, the first AGV 104a communicates, to the control server 108, a notification indicating that the first movable operator station 106a is installed at the first location. The process proceeds to step 1720, where the control server 108 updates the virtual map 1614a, which is stored in the memory 1604, to indicate, in the updated virtual map 1614b, that the first movable operator station 106a is now installed at the first location.

In the current embodiment, for the sake of brevity, it is assumed that transportation of the first movable operator station 106a between various locations is facilitated by the first AGV 104a. However, in an actual implementation, any operation (e.g., transportation of the first movable operator station 106a) performed by the first AGV 104a may be performed by any other AGV, of the set of AGVs 104, without deviating from the scope of the disclosure. In other words, any of the second through n^{th} AGVs 104b-104n may be selected, in lieu of the first AGV 104a, to perform any operation performed by the first AGV 104a.

Techniques consistent with the present disclosure provide, among other features a method and system for implementation of dynamic workstations in the storage facility 102. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the width or scope.

Various embodiments of the disclosure provide a system that prevents a need for manual intervention in setting up or installation of operator stations (e.g., PPSs or workstations). The operator stations are designed to be movable (e.g., dynamic), enabling quick changes in the layout of the storage facility 102 to meet changing business requirements and/or changing operating parameters. This increased flexibility in installation of operator stations results in better business outcomes for any organization that manages or is associated with the storage facility 102. A design of the first movable operator station 106a (or any of the set of movable operator stations 106) enables the first movable operator station 106a to be packed into a compact unit when the first movable operator station 106a is to be transported from one location to another. For example, the first set of linking members 702a and the second set of linking members 702b collapse when the second base plate 212 is slid to the third position from the fourth position. This results in the collapse of the second and fourth multi-tier structures, rendering the first movable operator station 106a compact and easy to transport to the first location from the current location of the first movable operator station 106a. As described in the foregoing description of FIG. 1, when the first movable operator station 106a is not in use, the first movable operator station 106a may be stowed away in the secondary storage area, freeing up space in the storage facility 102 for utilization for other activities.

Further, the design of the first movable operator station 106a allows for provisioning of additional inventory or storage space when required. For example, when the second base plate 212 is slid to the fourth position from the third position, the first set of linking members 702a and the second set of linking members 702b extend (e.g., expend), forming the second and fourth multi-tier structures in conjunction with the first and second support units 214a and 214b, respectively. Further, first movable operator station 106a includes the imaging device 222 that provides the set of visual cues to the operator at the first movable operator station 106a, increasing a convenience and an efficiency of the operator. Therefore, various embodiments of the disclosure improve a throughput and an efficiency of the entire storage facility 102.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. A movable operator station comprising:
a first base plate oriented parallel to a floor surface in “XY” plane;
a set of support members attached to a bottom surface of the first base plate to maintain a gap between the first base plate and the floor surface;
a first multi-tier structure slidably coupled to the first base plate, wherein the first multi-tier structure is slidable along “X” axis between a first position and a second position;
a second base plate slidably coupled to the first base plate, wherein the second base plate is slidable along “Y” axis between a third position and a fourth position;
a first support unit slidably coupled to the second base plate, wherein the first support unit is slidable along the “X” axis; and
a first set of linking members that links the first multi-tier structure to the first support unit, wherein:
the first set of linking members extends or collapses based on a movement of the second base plate along the “Y” axis, and
the first support unit is slidable along the “X” axis in conjunction with the first multi-tier structure, whereby the first support unit and the first set of linking members form a second multi-tier structure when the second base plate is at the fourth position.

2. The movable operator station of claim 1, further comprising:
a third multi-tier structure slidably coupled to the first base plate, wherein the third multi-tier structure is slidable along the “X” axis between a fifth position and a sixth position;
a second support unit slidably coupled to the second base plate, wherein the second support unit is slidable along the “X” axis; and
a second set of linking members that links the third multi-tier structure to the second support unit, wherein:
the second set of linking members extends or collapses based on a movement of the second base plate along the “Y” axis, and
the second support unit is slidable along the “X” axis in conjunction with the third multi-tier structure, whereby the second support unit and the second set of linking members form a fourth multi-tier structure when the second base plate is at the fourth position.

3. The movable operator station of claim 1, further comprising:
a first set of sliding members mounted on a top surface of the first base plate, wherein the first multi-tier structure is slidably coupled to the first base plate by way of the first set of sliding members.

4. The movable operator station of claim 1, further comprising:
a second set of sliding members attached to the bottom surface of the first base plate, wherein the second base plate is slidably coupled to the first base plate by way of the second set of sliding members.

5. The movable operator station of claim 1, further comprising:
a set of wheels attached to a bottom surface of the second base plate and in contact with the floor surface, wherein the set of wheels rotates to facilitate movement of the second base plate along the “Y” axis.

6. The movable operator station of claim 1, further comprising:
an identification marker attached to the bottom surface of the second base plate.

7. The movable operator station of claim 1, further comprising:
a vertical frame attached to the first base plate and oriented parallel to “XZ” plane.

8. The movable operator station of claim 7, further comprising:
an imaging device mounted on top of the vertical frame to provide a set of visual cues to an operator at the movable operator station.

9. The movable operator station of claim 1, wherein the first set of linking members includes a set of telescopic foldable tubes, wherein the set of telescopic foldable tubes expand when the second base plate is slid to the fourth position, and wherein the set of telescopic foldable tubes collapse when the second base plate is slid to the third position.

10. A system for implementation of dynamic workstations, comprising:
a set of movable operator stations, wherein each of the set of movable operator stations includes:
a first base plate oriented parallel to a floor surface in “XY” plane;
a set of support members attached to a bottom surface of the first base plate to maintain a gap between the first base plate and the floor surface;
a first multi-tier structure slidably coupled to the first base plate, wherein the first multi-tier structure is slidable along “X” axis between a first position and a second position;
a second base plate slidably coupled to the first base plate, wherein the second base plate is slidable along “Y” axis between a third position and a fourth position;
a first support unit slidably coupled to the second base plate, wherein the first support unit is slidable along the “X” axis; and
a first set of linking members that links the first multi-tier structure to the first support unit, wherein:
the first set of linking members extends or collapses based on a movement of the second base plate along the “Y” axis, and
the first support unit is slidable along the “X” axis in conjunction with the first multi-tier structure, whereby the first support unit and the first set of linking members form a second multi-tier structure when the second base plate is at the fourth position;
a server, configured to:
determine, from a plurality of locations in a storage facility, a first location for installation of a first movable operator station, of the set of movable operator stations, within the storage facility; and
an automated guided vehicle, configured to:
receive, from the server, a set of instructions to transport the first movable operator station to the determined first location, and
transport, based on the received set of instructions, the first movable operator station from a current location of the movable operator station to the determined first location.

11. The system of claim 10, wherein each of the set of movable operator stations further includes:
a third multi-tier structure slidably coupled to the first base plate, wherein the third multi-tier structure is slidable along the “X” axis between a fifth position and a sixth position;
a second support unit slidably coupled to the second base plate, wherein the second support unit is slidable along the “X” axis; and
a second set of linking members that links the third multi-tier structure to the second support unit, and wherein:
the second set of linking members extends or collapses based on a movement of the second base plate slide along the “Y” axis, and
the second support unit is slidable along the “X” axis in conjunction with the third multi-tier structure, whereby the second support unit and the second set of linking members form a fourth multi-tier structure when the second base plate is at the fourth position.

12. The system of claim 10, wherein each of the set of movable operator stations further includes a first set of sliding members mounted on a top surface of the first base plate, and wherein the first multi-tier structure is slidably coupled to the first base plate by way of the first set of sliding members.

13. The system of claim 10, wherein each of the set of movable operator stations further includes a second set of sliding members attached to the bottom surface of the first base plate, and wherein the second base plate is slidably coupled to the first base plate by way of the second set of sliding members.

14. The system of claim 10, wherein each of the set of movable operator stations further includes a set of wheels attached to a bottom surface of the second base plate and in contact with the floor surface, and wherein the set of wheels rotates to facilitate movement of the second base plate along the “Y” axis.

15. The system of claim 10, and wherein each of the set of movable operator stations further includes an identification marker attached to the bottom surface of the second base plate.

16. The system of claim 15, wherein the set of instructions is indicative of the identification marker of the first movable operator station.

17. The system of claim 10, wherein each of the set of movable operator stations further includes a vertical frame attached to the first base plate and oriented parallel to “XZ” plane.

18. The system of claim 17, wherein each of the set of movable operator stations further includes an imaging device mounted on top of the vertical frame to provide a set of visual cues to an operator at the movable operator station.

19. The system of claim 10, wherein the server is further configured to determine, for each of the plurality of locations, a level of throughput of the first movable operator station, and wherein determination of the first location, for the installation of the first movable operator station, is based on the determined level of throughput of the first movable operator station for the first location.

20. The system of claim 10, wherein the server is further configured to determine a current availability of each of the plurality of locations in the storage facility, and wherein the determination of the first location, for the installation of the first movable operator station, is based on the current availability of the first location.
